(19) United States
(12) Patent Application Publication
(10) Pub. No.: US 2008/0162354 A1
(43) Pub. Date: Jul. 3, 2008

(54) METHOD FOR DETERMINING THE PRICE OF SUPERDISTRIBUTED RECORDINGS

(75) Inventors: Jukka Alve, Vantaa (FI); Pekka Lahtinen, Helsinki (FI); Matti Puputti, Turku (FI); Samuli Tuoriniemi, Oulu (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/618,312

(22) Filed: Dec. 29, 2006

(51) Int. Cl. G06Q 99/00; H04L 9/32

(52) U.S. Cl. 705/51; 705/1; 705/400

(57) ABSTRACT

A method, apparatus or tangible computer medium (which stores computer executable code or program code) performs or facilitates: receiving from a first remote device protected content along with pricing attribute information for the protected content; requesting access to the protected content from a second remote device, the requesting including transmitting of the pricing attribute information to the second remote device which is authorized to act on behalf of a provider of the content; and obtaining access to the protected content from the second remote device according to a pricing or valuation of the protected content based on the pricing attribute information received by the second remote device.

### FIELD OF THE INVENTION

The present invention relates to communications and, more particularly, to techniques for managing the distribution of and access to content.

### BACKGROUND

Content, such as television broadcasts, Internet content, and content stored on prerecorded media are valuable commodities in the current economy. Accordingly, there is an interest in protecting such content from illegal copying. Presently, content may be delivered from a content distributor to particular devices in various formats. For example, content may be delivered in an unprotected or encrypted manner. Also, content may be protected using conditional access (CA) or digital rights management (DRM) technologies. However, there is currently a need for techniques that manage the authorized distribution of content among multiple devices, including the pricing thereof, once such content is delivered.

It is desirable for such techniques to be backwards compatible with existing receiver design conventions. This is particularly important in a broadcast scenario, in which existing legacy receivers must still be able to access the broadcast, but improved copy protection is required of new devices that are capable of making digital recordings of the broadcast content. One such convention requires receivers to protect received content by encrypting it upon receipt. Current proposals for such encryption by receivers involve the use of random numbers as encryption keys. These encryption keys are called content keys. Once the content is encrypted, the receivers protect the content keys by encrypting them. This encryption can be performed with a device key when the associated content is bound to a particular device. Alternatively, this encryption can be performed with a domain key when the associated content is bound to a set of devices, referred to as a domain.

An entity called a rights issuer (e.g., authorized agent) has been proposed. This entity is allowed to perform functions such as the modification of usage rules associated with particular content, as well as the modification of the binding of content to a device or a set of multiple devices also known as a domain. Additionally, a rights issuer may be permitted to modify a domain. It is desirable to use a rights issuer to provide for the distribution of delivered content among multiple devices.

### SUMMARY

In accordance with an embodiment, a method, apparatus or tangible computer medium (which stores computer executable code or program code) performs or facilitates: receiving from a first remote device protected content along with pricing attribute information for the protected content; requesting access to the protected content from a second remote device, the requesting including transmitting of the pricing attribute information to the second remote device which is authorized to act on behalf of a provider of the content; and obtaining access to the protected content from the second remote device according to a pricing or valuation of the protected content based on the pricing attribute information received by the second remote device.

In accordance with an embodiment, a method, apparatus or tangible computer medium (which stores computer executable code or program code) performs or facilitates: obtaining authorization to make a recording of content from a content provider through a service; receiving protected content from the content provider; making an authorized recording of the protected content in a file, the file further including information corresponding to pricing attributes for subsequent valuation of the recorded content when redistributed; and transmitting a copy of the file with the protected content and the information corresponding to the pricing attributes to another party.

In accordance with an embodiment, a method, apparatus or tangible computer medium (which stores computer executable code or program code) performs or facilitates: receiving from a communications device a request for access to protected content obtained by the communications device and having associated therewith pricing attribute information, the request including the pricing attribute information for the protected content; verifying that the received pricing attribute information has not been altered or is valid; determining a price for access of the protected content by the communications device according to the verified pricing attribute information; and transmitting a key to the communications device to allow access to the protected content upon payment of the price.

These and other exemplary embodiments and aspects are described in greater detail below.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The various exemplary embodiments will be described with reference to the accompanying drawings, wherein:

FIG. 1 is a diagram of an exemplary operational environment, in which content may be distributed according an embodiment;

FIG. 2 is a block diagram of a first exemplary operational scenario;

FIG. 3A is a block diagram of an exemplary device implementation that may be employed in the first operational scenario;

FIGS. 3B and 3C are block diagrams of exemplary implementations to protect and extract, respectively, pricing attribute information in accordance with an embodiment;

FIGS. 3D and 3E are block diagrams of exemplary implementations to protect and extract, respectively, pricing attribute information in accordance with an embodiment;

FIGS. 3F and 3G are block diagrams of exemplary implementations to protect and extract, respectively, pricing attribute information in accordance with an embodiment;

FIGS. 3H and 3I are block diagrams of exemplary implementations to protect and extract, respectively, pricing attribute information in accordance with an embodiment;

FIGS. 3J and 3K are block diagrams of exemplary implementations to protect and extract, respectively, pricing attribute information in accordance with an embodiment;

FIGS. 4A through 4C are block diagrams of exemplary device and rights issuer implementations that may be employed in the first operational scenario;

FIG. 5 is a block diagram of an exemplary second operational scenario;

FIG. 6 is a block diagram of an exemplary device implementation that may be employed in the second operational scenario;

FIG. 7 is a block diagram of exemplary device and rights issuer implementations that may be employed in the second operational scenario;

FIG. 8 is a block diagram of an exemplary third operational scenario;

FIG. 9 is a block diagram of an exemplary device implementation that may be employed in the third operational scenario;

FIG. 10 is a block diagram of exemplary device and rights issuer implementations that may be employed in the third operational scenario;

FIG. 11 is a block diagram of an exemplary fourth operational scenario;

FIG. 12 is a block diagram of an exemplary device implementation that may be employed in the fourth operational scenario;

FIG. 13 is a block diagram of exemplary device and rights issuer implementations that may be employed in the fourth operational scenario;

FIG. 14 is a block diagram of an exemplary access module and an exemplary user output module;

FIG. 15 is a flowchart of an exemplary process in accordance with an embodiment;

FIG. 16 is a flowchart of an exemplary operational sequence that may be performed by a rights issuer;

FIG. 17 is a flowchart of an exemplary operational sequence that may be performed by a rights issuer;

FIG. 18 is a flowchart of an exemplary operational sequence that may be performed by a device;

FIG. 19 is a flowchart of an exemplary operational sequence that may be performed by a device; and

FIG. 20 is a block diagram of an exemplary computer system.

### DETAILED DESCRIPTION OF VARIOUS EMBODIMENTS

### I. Operational Environment

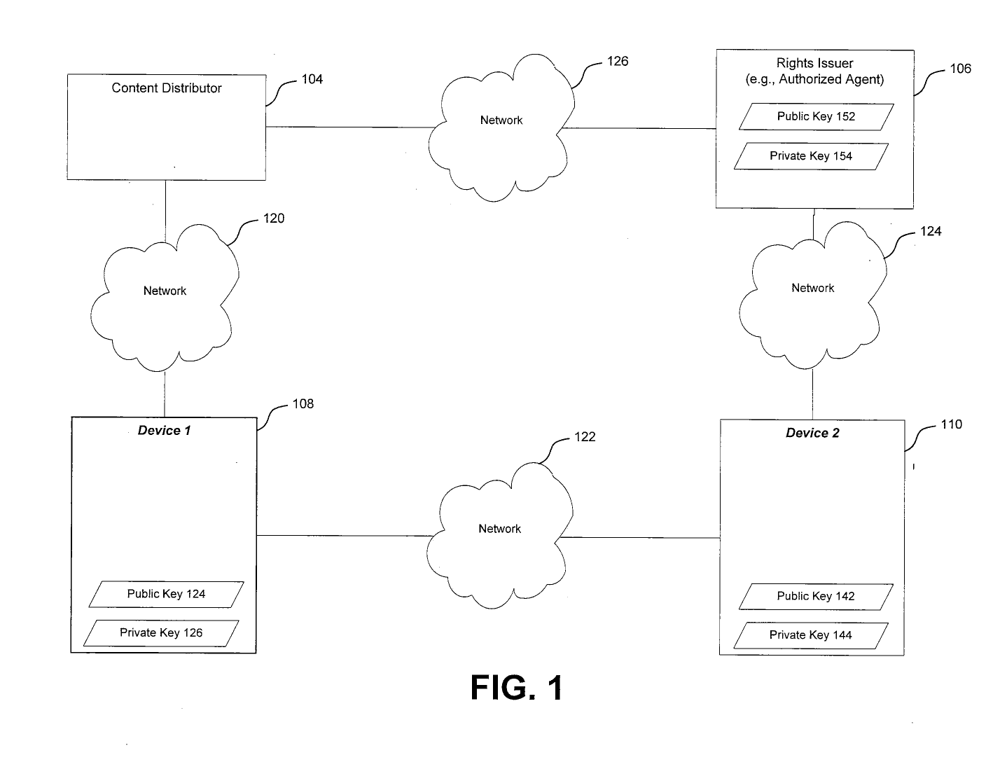

Before describing the various embodiments in detail, it is helpful to describe an environment in which one or more of the exemplary embodiments may be used. Accordingly, FIG. 1 is a diagram of an operational environment where content may be distributed among devices according to an embodiment. This environment includes a content distributor 104, a rights issuer (or authorized agent) 106, a first device 108, and a second device 110. Devices 108 and 110 may be associated with a single user or different users.

Content distributor 104 may include a content provider and/or a service provider, which transmits content items to one or more devices or offers services related to the distribution of content items. Examples of content items include (but are not limited to) video broadcasts, multimedia content, hypertext documents, and files. Content distributor 104 may be, for example, a digital video broadcaster. Such transmissions may be in either protected (e.g., conditional access encrypted) or unencrypted formats. If implemented in a service environment, a device may need to register with the service beforehand. The registration may involve providing identification information of the user or device, payment or account information and so forth to the content distributor, and the provision of information or data to facilitate delivery of the service, including various keys (e.g., content item encryption key (CIEK), pricing attribute key, etc.) to the device.

FIG. 1 shows that public and private encryption key pairs are associated with devices 108 and 110. In particular, first device 108 has a public key 124 and a corresponding private key 126. Second device 110 has a public key 142 and a corresponding private key 144. In addition, a public key 152 and a corresponding private key 154 are associated with rights issuer 106. With corresponding public and private keys, these devices may employ asymmetric encryption techniques to encrypt and decrypt information, such as content items, pricing attribute information (described in more detail below), encryption keys or any other information to be protected.

Various networks couple the devices of FIG. 1. For instance, a network 120 couples content distributor 104 and first device 108, a network 122 couples first device 108 and second device 110, a network 124 couples second device 110 and rights issuer 106, and a network 126 couples rights issuer 106 and content distributor 104.

Networks 120, 122, 124, and 126 may each be any suitable network that enables the transfer of information between the coupled devices and entities. For instance, network 120 may be a broadcast network. Examples of broadcast networks include terrestrial and satellite wireless television distribution systems, such as DVB-T, DVB-C, DVB-H (DVB handheld), ATSC, and ISDB systems. Network 120 may also be a broadcast cable network, such as a Data Over Cable Service Interface Specification (DOCSIS) network. Alternatively, network 120 may be a packet-based network, such as the Internet.

As a further example, one or more of networks 120, 122, 124, 126 may be wireless cellular networks. In addition, one or more of these networks may be short-range proximity networks, which employ technology, such as Bluetooth or Ultra-Wideband (UWB) or etc. Accordingly, one or more of devices 104, 106, 108, and 110 may be implemented as mobile phones. Although FIG. 1 illustrates distinct networks, in embodiments, a single network may replace two or more of networks 120, 122, 124, and 126.

Moreover, between the devices and entities of FIG. 1, there may be in some embodiments not only a single network but two or more networks. These networks may be used for messaging and/or (content) data transfer between the devices and entities. For example, a user terminal (such first device 108) may comprise a DVB receiver, a mobile phone and in addition have a Bluetooth connection.

As described above, content can be distributed among devices. For example, content distributor 104 may transmit a content item that is authorized for reception by first device 108. Upon receipt of this content item, the user of first device 108 may desire to forward this content to second device 110. According to the various embodiments, first device 108 may transfer the content item (as well as other associated information) to second device 110. However, for device 110 to use (e.g., access) the content item, it must first obtain information from rights issuer 106. Basically, second device 110 may get information from the original content provider/owner/distributor, but rights issuer 106 can act on behalf of the content provider to allow device 110 to access the information as well as to conduct transactions including the pricing and payment to obtain access to the content item.

Thus, to facilitate pricing of distributed or superdistributed content item(s) such as by rights issuer 106 or content distributor 104, a recorded content item may be distributed along with pricing attribute information to facilitate subsequent pricing or valuation of such content item. By way of example, first device 108 may transfer content (e.g., content item) with pricing attribute information. In certain cases, this pricing attribute information needs to be added by the first device, because it reflects reception conditions, choices made by the user making the recordings etc., which the rights issuer otherwise would not know. Subsequently, a party (e.g., second device 110) receiving the content with pricing attribute information may forward a request for access to the content along with the pricing attribute information to a rights issuer (e.g., rights issuer 106 or content distributor 104). The rights issuer can then price or determine a valuation of access to the content based on at least the pricing attribute information, conduct a payment transaction, and allow access to the content by responding or communicating access information such as in the form of a rights object or the like.

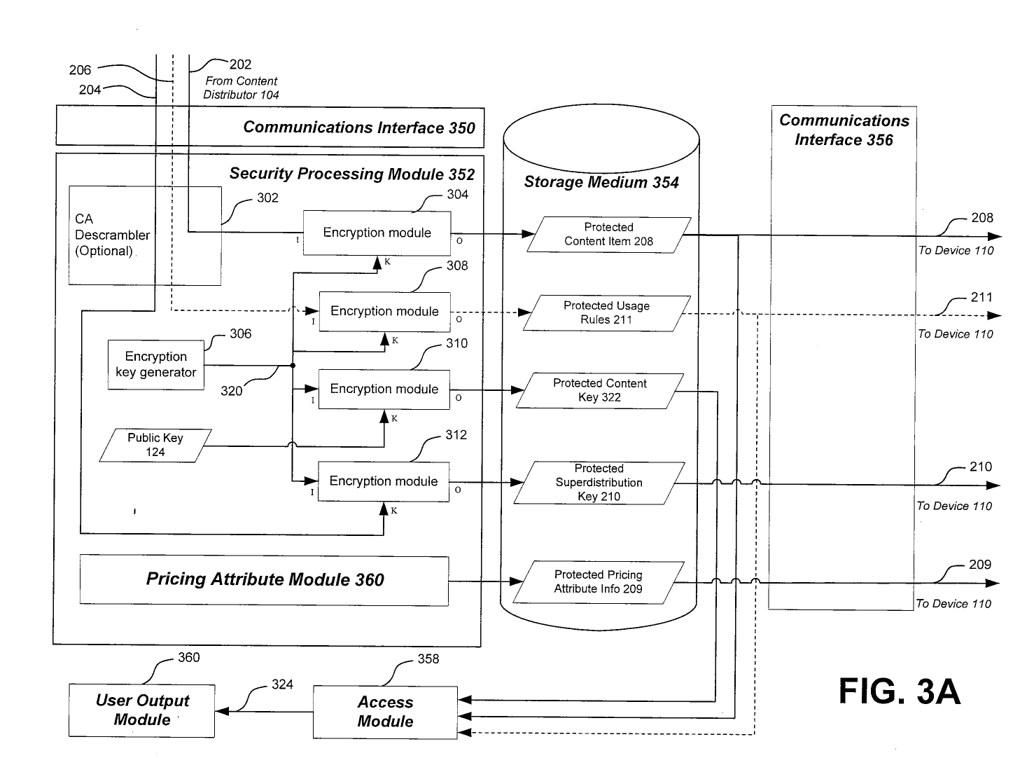

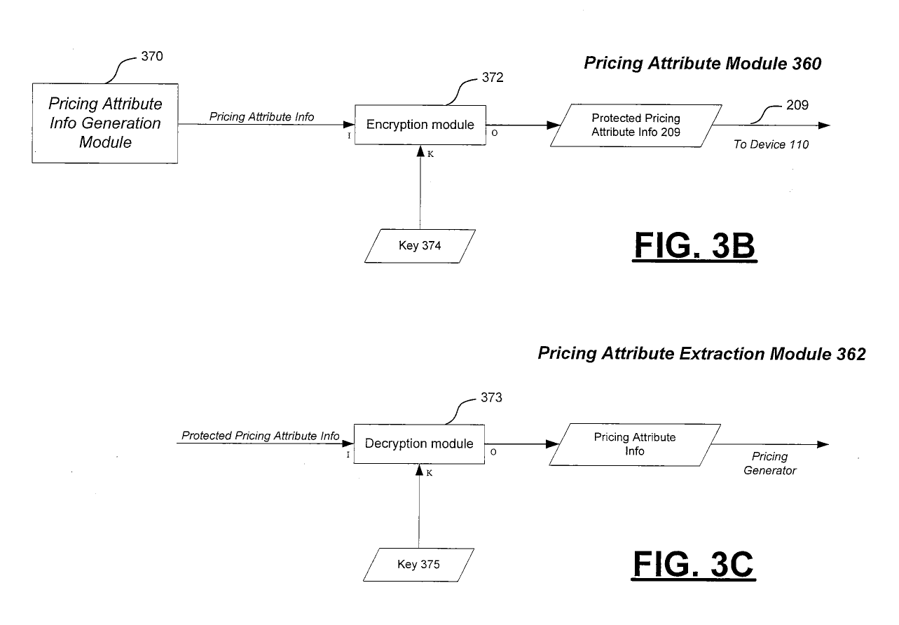

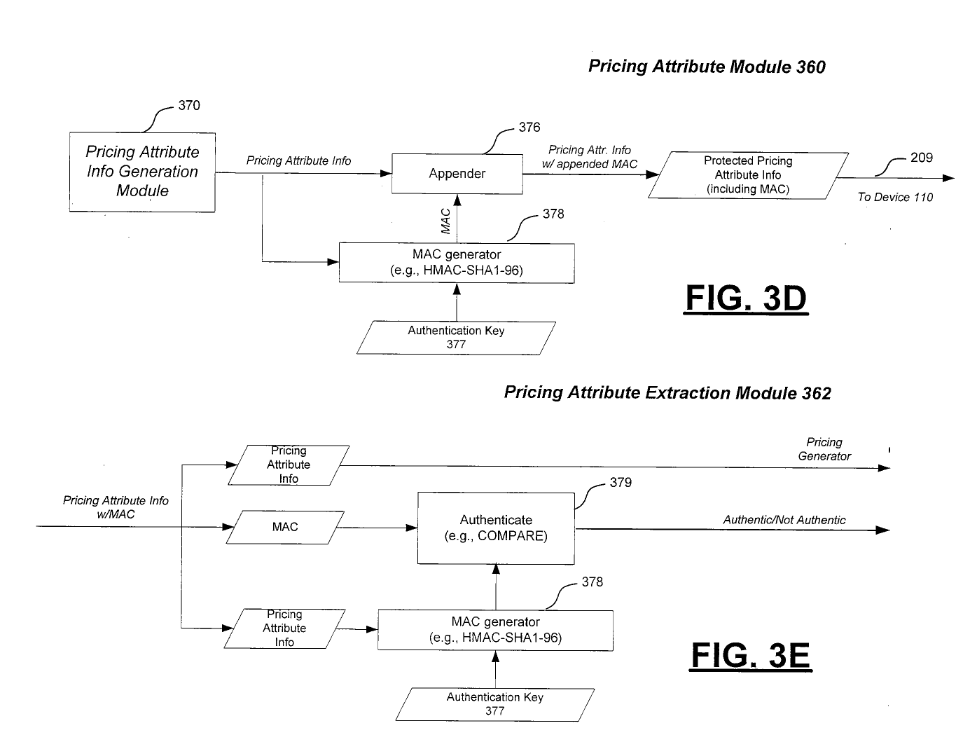

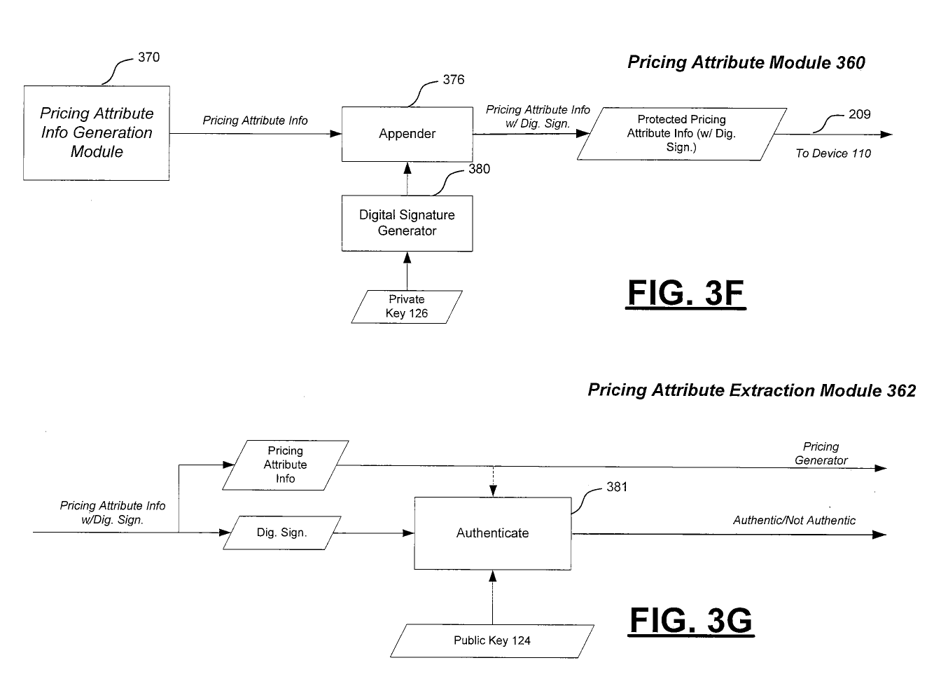

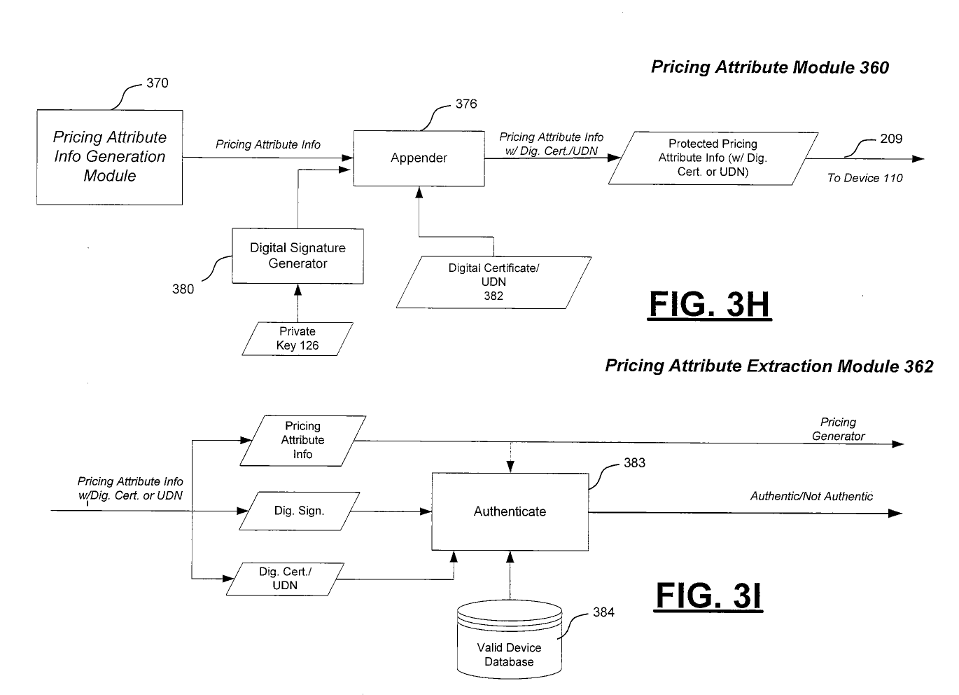

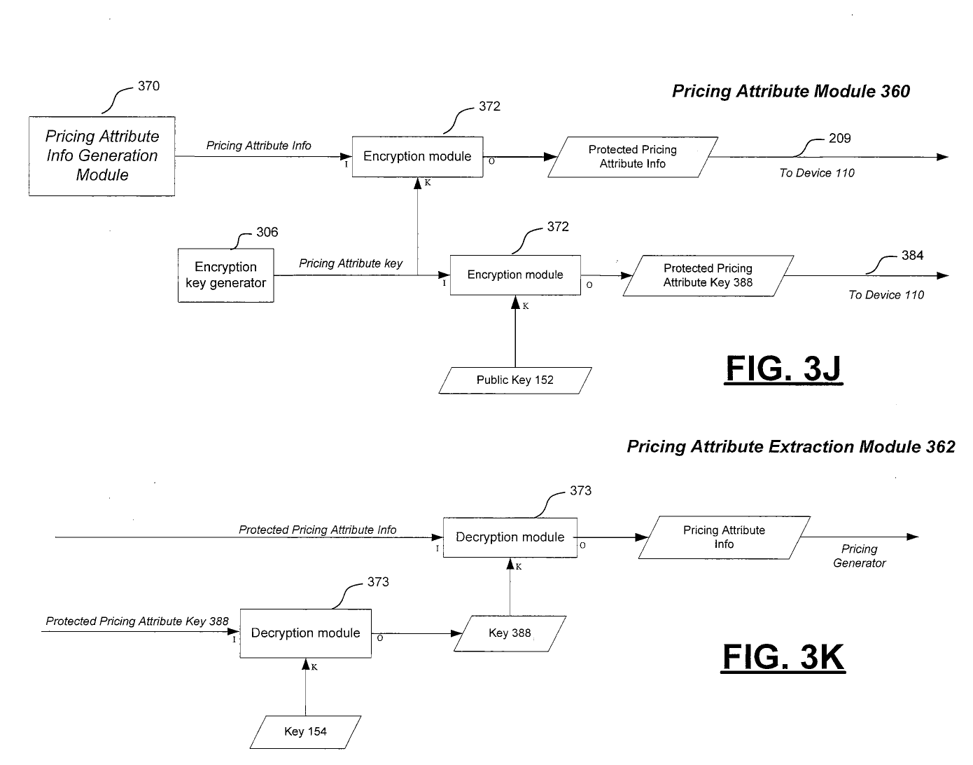

To reduce or identify fraud in this pricing implementation (e.g., unauthorized tampering or alteration of the information), the pricing attribute information may be protected, e.g., encrypted or authenticated as being from or endorsed by an authorized or legitimate entity or party (such as through digital certificates or signatures) or a combination thereof. Various exemplary protection schemes are described in further detail below with reference to FIGS. 3B through 3K. Further, the various exemplary protection schemes employed for content item or other keys (e.g., content or content item key, superdistribution key, etc.), as described herein, may likewise be employed to protect the pricing attribute information or pricing attribute key.

Pricing attribute information may include any type of information related to the recorded content item and usable to price or perform a valuation of that item. For example, this information may include: (1) a location or locality in or for which a content item was recorded (e.g., North America, Europe, etc.), (2) quality of the recording of the content item which may be expressed quantitatively or qualitatively and include error information (e.g., error free, multiple errors, etc.), video/audio/data quality (e.g., high, medium, low), etc. (3) quality of the content of the item, such as whether the content item includes or not advertisements or other content, (4) whether the content as recorded was modified (e.g., remove advertisement, add advertisements, etc.) or (5) other information pertaining to an attribute or characteristic of the content as recorded and distributed. This information may be generated, updated, computed or gathered in various ways, for example, by monitoring or evaluating attributes or characteristics of the content item during transmission or recording of the content item.

Pricing attribute information may be evaluated alone or in combination with other factors to price or perform valuation of a content item, e.g., discount, increase or select a price. For example, a price of a content item may be increased for premium content (e.g., error free, advertisement free, high definition, etc.) or decreased for standard or below standard content (e.g., a few or many errors, advertisements, etc.). A price of a content item may be determined or selected (e.g., from a table) or calculated based on a pricing table and/or based on a pricing formula or equation (e.g., price(base)±price(pricing attribute)) according to or based on the pricing attributes associated with the content item. The pricing scheme may employ weighting such as of pricing attributes, content item, etc. For example, whether a recording has errors or advertising may have a greater weight or cost factor than other pricing attributes.

The provision of a pricing scheme, as described herein, thus provides an approach to facilitate management of distributed content item, and can also be incorporated into existing or developing broadcast standards or approaches. For example, the Open Mobile Alliance (OMA) has proposed Digital Rights Management (DRM) standards, e.g., Versions 1.0 and 2.0, the latter which is currently being extended for Broadcast Services. Currently, there is a proposal to employ a recorded content file format or protocol that includes a header with a recording information block (RIB). The RIB includes an identifier for the service through which the content was received, start and end time of the recording, and a content item encryption key (CIEK) used for encrypting the content. There is however currently no other information currently available by which a rights issuer or the like can determine a price or value of the rights to a recording. As such, with reference to this proposed broadcasting scheme, the RIB may be modified to incorporate or include pricing attribute information as described herein in accordance with an embodiment. The entire RIB may thus be protected through the various protection schemes described herein and provided to a rights issuer to obtain a rights object in order to access the associated content item.

Turning back to FIG. 1, rights issuer 106 is involved in managing the distribution of content among devices. Rights issuer 106 is trusted by content distributor 104 and is authorized to act on its behalf. Thus, when rights issuer 106 is implemented as an entity distinct from content distributor 104, it may perform acts that, in principle, are imputed to content distributor 104. Examples of such acts include changing existing usage rules, creating new usage rules, transacting business for access to content such as determining pricing for content and obtaining payments, and so forth.

However, content distributor 104 may set limits to the authorization given to rights issuer 106. For instance, content distributor 104 may impose temporal limits on this authorization. Such temporal limits may specify a particular time (e.g., month/day/year) at which this authorization expires. In addition, content distributor 104 may revoke this authorization at any time.

Moreover, any authorization that content distributor 104 grants to rights issuer 106 may include various limitations and/or qualifications. For example, content distributor 104 may limit authorization to certain types of content. Such content types include low-priced content, obsolete content, lower grade content, or any combination of these. Thus, content distributor 104 may impose restrictions (or limited authority) upon rights issuer 106 so that it is not allowed to perform all of the functions that content distributor 104 may perform.

Rights issuer 106 may be locally accessible by second device 110. For example, rights issuer 106 may be positioned at a publicly available location, such as a kiosk that is near second device 110. Accordingly, in such implementations, network 124 may be an ad hoc proximity network, such as a Bluetooth network. Further, rights issuer 106 may be located in a different area or region than content distributor 104. In such locations, the ‘original’ owner of rights (i.e., content distributor 104) may not be accessible. Thus, rights issuer 106 provides for local content access instead of central content access from content distributor 104. This feature relieves communications and processing loads from content distributor 104.

Although FIG. 1 only shows a single content distributor, rights issuer 106 may be trusted by multiple content distributors. Similarly, although FIG. 1 only shows a single rights issuer (e.g., authorized agent), content distributor 104 may trust multiple rights issuers. Also, in the various exemplary embodiments herein, content distributor 104 may perform the role of rights issuer 106.

As described above, rights issuer 106 may be implemented in a mobile phone. In such implementations, rights issuer 106 may operate as a personal rights issuer for an individual, or a shared rights issuer between multiple people (e.g., family members).

As described above, content distributor 104 transmits content items. Each of these content items may be associated with one or more usage rules. These usage rules state the rights of the user or possessor of the corresponding content items to render, copy, store and/or transfer the received content. For example, usage rules may restrict the rendering of content items to a prescribed number of times. In addition, usage rules may restrict the transfer of content items to other devices and/or other users.

Usage rules may also set temporal restrictions regarding the use of corresponding content items. For example, a temporal usage rule may require that a content item shall only be stored for a prescribed period of time. In addition, usage rules may only have temporally limited validity.

In the various embodiments, usage rules may be expressed as one or more data files. These data files may be in various formats. For example, the data files may be in an XML-based markup language such as the Open Digital Rights Language (ODRL) or the eXtensible rights Markup Language (XrML). The data files may also be directly in XML. ODRL provides for the expression of terms and conditions involving content, such as permissions, constraints, and obligations. XrML provides techniques for specifying and managing rights and conditions associated with content.

Content distributor 104 may transmit one or more usage rules along with a content item. The usage rules may be expressed in a voucher. Such a voucher may include data identifying the corresponding content item, the content distributor, the content distributor, and the usage rules. For example, OMA DRM 2.0 calls such voucher a Rights Object. In addition, a voucher may include one or more encryption keys either in plain form (public keys) or encrypted. The voucher may have restricted validity.

Alternatively, a content item and its associated usage rules and/or vouchers may be delivered separately from each other. Thus, a content item and its associated usage rules and/or vouchers may be transmitted at different times, and/or across different media. Such content items, usage rules and vouchers may include pointers. This allows them to be associated with each other when necessary.

### II. Operational Scenarios

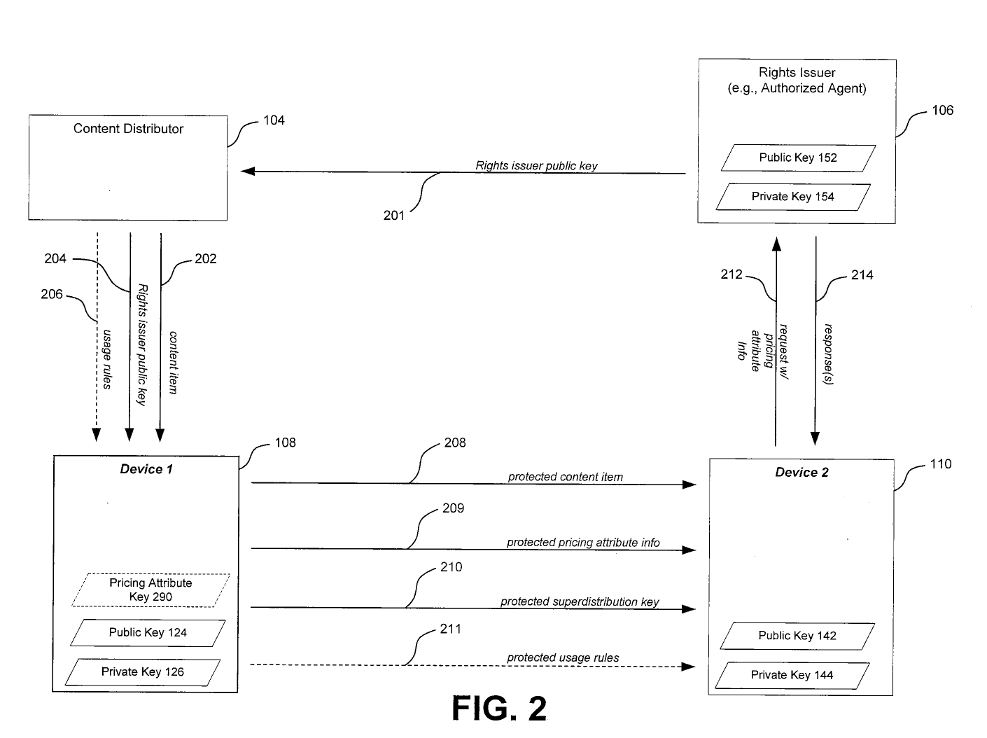

According to the various exemplary embodiments, a number of exemplary scenarios may be employed to distribute content between devices. Examples of such scenarios are illustrated in FIGS. 2-13. In these examples, content along with pricing attributes information is transferred between first device 108 and second device 110. However, these scenarios involve the exchange of information between content distributor 104, first device 108, second device 110, and rights issuer 106. For convenience, FIGS. 2-13 do not illustrate networks 120, 122, 124, and 126. However, these networks may be used to facilitate the communications shown in these drawings.

A. First Scenario

A first content distribution scenario is shown in FIGS. 2-4. FIG. 2 shows that in this scenario, content distributor 104 receives a transmission 201 from rights issuer 106. Transmission 201 includes public key 152 of rights issuer 106.

Content distributor 104 transmits to first device 108 a content item 202, and an encryption key 204 that is associated with rights issuer 106 (e.g., public key 152). Also, content distributor 104 may send to first device 108 usage rules 206 which correspond to content item 202. Content distributor 104 may transmit this information to first device 108 in either protected or unprotected formats. An example of a protected format is conditional access (CA) encrypted. Another example of protected format is the one defined by IP Datacast over DVB-H Service Purchase and Protection system, ETSI TS 102 474, which is available at “http://www.etsi.org/”.

Based on this information, first device 108 generates a protected content item 208, generates or updates (or modifies) pricing attribute information associated with the protected content item 208, and generates a protected superdistribution key 210, all of which are sent to second device 110. In addition, first device 108 may generate protected usage rules 211 and send them to second device 110. Protected content item 208 and protected usage rules 211 are each encrypted with a content key generated by first device 108. First device 108 encrypts this content key with encryption key 204 to generate protected superdistribution key 210. As described above, encryption key 204 is associated with rights issuer 106. The pricing attribute information 209 may also be protected, and may be sent together with the content item 208 such as in a block, segment or field of a header information of the content item 208 or sent as a separate file bundled together with the protected content item.

Although second device 110 receives protected content item 208, protected pricing attributes information 209, protected superdistribution key 210, and protected usage rules 211, it is unable to access the underlying content of protected content item 208. This is because protected superdistribution key 210 is encrypted with a key that is specific to rights issuer 106, and not accessible by second device 110. Accordingly, second device 110 relies on rights issuer 106 to decrypt protected content item 208. Decryption or access to the content item may require payment from the second device 110 or its user.

More particularly, second device 110 sends a content key request 212 to rights issuer 106. Request 212 includes protected superdistribution key 210 and protected pricing attribute information 209. In addition, request 212 may include public key 142 of second device 110. Also, request 212 may include protected usage rules 211.

In response to request 212, rights issuer 106 determines a pricing or value for the content item based on the pricing attribute information and conducts a transaction for payment by second device or its user of the determined price before access or authorization to the content item is allowed or given. The transaction may involve additional communications between the rights issuer 106 and second device 110 to obtain payment information or authorization, or may involve automatically charging of an account related or associated with second device 110 or its user. Payment or satisfaction thereof may be implemented in other manners than the above examples.

Upon satisfaction of the payment, a response 214 is sent to second device 110. Response 214 includes a rights object, e.g., a secure content key. This secure content key is the content key generated by first device 108, but encrypted with public key 142 of second device 110.

At this point, second device 110 may decrypt the secure content key received in response 214 with private key 144. As a result of this decryption, second device 110 obtains the key used by first device 108 when encrypting protected content item 208. With this content key, second device 110 may decrypt and access the underlying content of protected content item 208 (i.e., content item 202).

FIG. 3A is a block diagram of an exemplary first device 108 implementation that may be employed in the exemplary scenario of FIG. 2. This implementation includes a first communications interface 350, a security processing module 352, a pricing attribute module 360, a storage medium 354, and a second communications interface 356. In addition, the implementation of FIG. 3 includes an access module 358 and a user output module 360. In the various embodiments, first device 108 implementations may have further communications interfaces to provide for the transfer of messaging and content across different communications media.

First communications interface 350 includes hardware and/or software to provide for the reception of transmissions from content distributor 104. As shown in FIG. 3, first communications interface 350 receives content item 202, encryption key 204, and usage rules 206. This information is transferred to security processing module 352.

Security processing module 352 performs various operations involving, for example, encryption, decryption, and key generation. As shown in FIG. 3, security processing module 352 includes an optional CA descrambler 302, and an encryption key generator 306 (e.g., a random number generator). In addition, security processing module 352 includes encryption modules 304, 308, 310, and 312.

Pricing attribute module 360 performs various operations involving, for example, generation or modification or update of pricing attribute information, and encryption, decryption and/or key generation associated with the pricing attribute information. The pricing attribute information may be generated locally or received from a remote device, such as content distributor 104. The generation or modification or update of this information may be implemented before, after or during the recording of received content, such as from content distributor 104. For example, if errors are detected in the received and recorded content, then the pricing attribute information can be configured to reflect such error or the lack or error or the number of errors. Other types of information, such as those already discussed above (e.g., location, quality, modification of content, etc.) may likewise be configured accordingly in the pricing attribute information. Although pricing attribute module 360 is shown as being part of security processing module 352 in FIG. 3A, the module 360 may be configured as a wholly separate module or to work in conjunction with the various security capabilities of security processing module 352 to protect pricing attribute information. These various modules including their submodules or components may be implemented in hardware, software, firmware, or in any combination thereof.

If content distributor 104 employs conditional access protection, its transmissions are at least partly scrambled. Accordingly, descrambler 302 descrambles content item 202, encryption key 204, and usage rules 206. This type of protection may likewise be applied to pricing attribute information.

Encryption key generator 306, generates an internally generated encryption key 320, which is sent to encryption modules 304, 308, 310, and 312. As shown in FIG. 3A, each of these encryption modules has an input interface (indicated with an “I”) for receiving data, and an input interface (indicated with a “K”) for receiving an encryption key. In addition, each of these modules includes an output interface (indicated with an “O”) for outputting encrypted data. In the various embodiments, encryption key generator 306 includes a random number generator, which generates a random number. Encryption key 320 may be (or be based upon) this random number.

Encryption module 304 receives and encrypts content item 202 using, for example, internally generated content key 320. This encryption generates protected content item 208. Similarly, encryption module 308 receives and encrypts usage rules 206 using content key 320. This encryption generates protected usage rules 211.

Security processing module 352 encrypts content key 320 in two different ways. In the first way, encryption module 310 encrypts content key 320 with public key 124. This encryption generates a protected content key 322, which first device 108 may use for subsequent decryption of content item 202. In the second way, encryption module 312 encrypts content key 320 with encryption key 204. As described above with reference to FIG. 2, encryption key 204 is a key (such as public key 152) that is associated with rights issuer 106. This encryption generates protected superdistribution key 210.

Storage medium 354 may include random access memory (RAM), read only memory (ROM), flash memory, disk storage, and/or other suitable storage media. As shown in FIG. 3, storage medium 354 stores protected content item 208, protected usage rules 211, protected superdistribution key 210, protected content key 322, and protected pricing attribute information 209.

Protected content item 208, protected pricing attribute information 209, protected usage rules 211, and protected superdistribution key 210 are sent to communication interface 356 for transmission to second device 110. FIG. 3A shows this information being sent from storage medium 354. However, protected content item 208, protected pricing attribute information 209, protected usage rules 211, and protected superdistribution key 210 may alternatively be sent directly to communications interface 356 from encryption modules 304, 308, and 312 or from other components or pathways.

Second communications interface 356 includes hardware and/or software that allow for the transmission of information to second device 110. As shown in FIG. 3A, second communications interface 356 sends protected content item 208, protected pricing attribute information 209, protected usage rules 211, and protected superdistribution key 210 to second device 110.

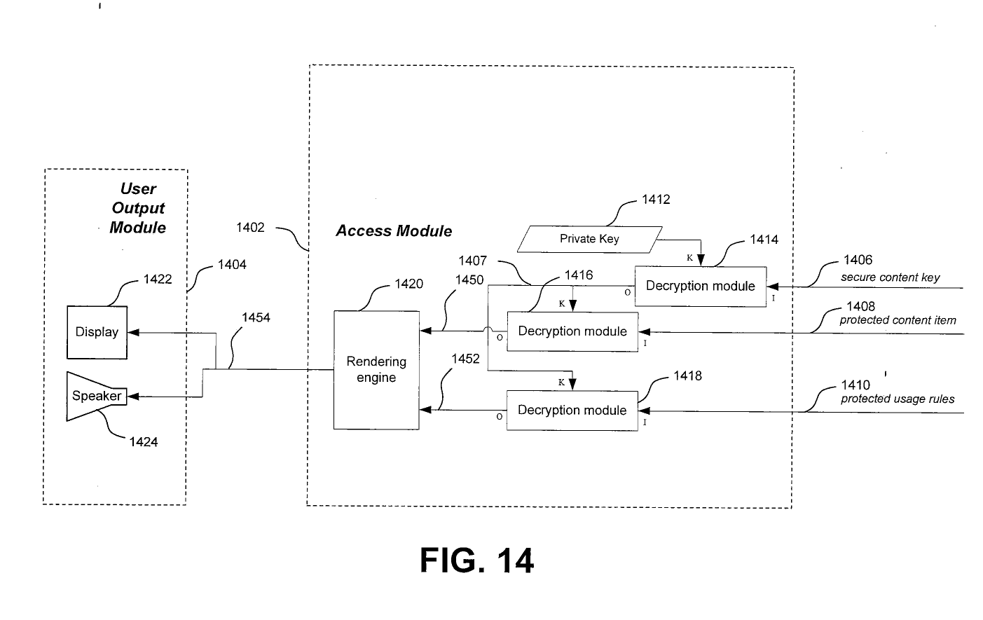

The first device implementation of FIG. 3A includes an access module 358 and a user output module 360. Access module 358 may receive protected content item 208, protected usage rules 211, and protected content key 322. From these inputs, access module 358 decrypts protected content item 208. In addition, access module 358 may decode or render decrypted content item 208 (i.e., content item 202) into an output signal 324. User output module 360 receives signal 324 and outputs it to a user of first device 108. Implementations of access module 358 and user output module 360 are described in greater detail below with reference to FIG. 14.

FIGS. 3B through 3K are block diagrams showing exemplary implementations of pricing attribute module 360 of second device 110 and corresponding pricing attribute extraction modules 362 such as implemented in rights issuer 106. For the purpose of explanation, each exemplary protection implementation for pricing attribute information will be described together with an extraction implementation. The components or modules of the modules 360 and 362 may be implemented in hardware, software, firmware, or in any combination thereof.

### 1. First Operational Example

FIGS. 3B and 3C are block diagrams of exemplary implementations to protect and extract, respectively, pricing attribute information in accordance with an embodiment. As shown in FIG. 3B, pricing attribute module 360 may include a pricing attribute information generation module 370 and encryption module 372.

Pricing attribute information generation module 370 can be configured to generate, update or modify pricing attribute information. This may involve monitoring and storing of attributes of received content or content as recorded, such as errors during transmission, quality of the received content or the content as recorded, locality where content is recorded, etc.

Similar to encryption module 306 (described above), encryption module 372 receives and encrypts information, in this case pricing attribute information, using a key 374. The key 374 may be the private key 126 of first device 108, the public key 152 of rights issuer 106, or a generated or received key such as a pricing attribute key (e.g., similar to a content key), etc. As shown in FIG. 3A, the protected pricing attribute information 209 can thereafter be stored and/or transmitted to another device, such as second device 110.

As shown in FIG. 3C, an example of pricing attribute extraction module 362 may be provided or employed at a device, such as rights issuer 106, to extract or access or verify the authenticity of protected pricing attribute information as generated in the example shown in FIG. 3B. For example, pricing attribute extraction module 362 may include a decryption module 373.

Decryption module 373 may be implemented in hardware, software, firmware, or in any combination thereof. As shown in FIG. 3C, decryption module 373 has an input interface (indicated with an “I”) for receiving encrypted data, and an input interface (indicated with a “K”) for receiving an encryption key. In addition, decryption module 373 includes an output interface (indicated with an “O”) for outputting decrypted data. Decryption module 373 is configured to decrypt the protected pricing attribute information using an appropriate key(s) 375, such as a public key 124, private key 154, or pricing attribute key or other suitable key.

### 2. Second Operational Example

FIGS. 3D and 3E are block diagrams of exemplary implementations to protect and extract, respectively, pricing attribute information in accordance with an embodiment. As shown in the example of FIG. 3D, pricing attribute module 360 may include a pricing attribute information generation module 370, an appender (or combiner) 376 and MAC generator 378.

As discussed above, pricing attribute information generation module 370 can be configured to generate, update or modify pricing attribute information. This may involve monitoring or evaluating and storing of attributes of received content or content as recorded, such as errors during transmission, quality of the received content or the content as recorded, locality where content is recorded, etc.

MAC generator 378 can be configured to generate or compute a message authentication code (MAC) using an authentication key 377 and the message, e.g., pricing attribute information. The MAC generator 378 may generate or compute the MAC using the algorithm HMAC-SHA1-96. A description of this algorithm is provided in the IETF (Internet Engineering Task Force) Network Working Group's Request for Comments (RFC) 2104 (HMAC: Keyed-Hashing for Message Authentication) (February 1997), which is incorporated by reference in its entirety. HMAC is a mechanism for message authentication using cryptographic hash functions. In this example, HMAC is used with an iterative cryptographic hash function, e.g., SHA-1-96, in combination with a secret shared key. The cryptographic strength of HMAC depends on the properties of the underlying hash function. As such, other hash functions than SHA-1-96 or even message authentication schemes may be employed to generate the MAC.

The authentication key 375 may be a key which is provided upon registration with a service, such as a content distributing and access authorization service associated with one or more content distributors (e.g., content distributor 104). For example, the authentication key 377 may be generated and/or provided by a trusted party, such as a content distributor 104 or service associated therewith, a rights issuer 106, etc. It is desirable that this key is not provided or communicated to devices, such as second device 110, to reduce or minimize the ability of unauthorized parties or devices from impermissibly or illegally altering the pricing information attribute.

Further, in the context of the proposed OMA DRM standard(s) (as described above), the pricing attribute information can be incorporated into the recording information block (RIB) and the authentication key 377 can be a RIB authentication key (RIBAK). In such an exemplary OMA DRM environment, the RIBAK can be delivered from the rights issuer to a trusted or authorized device, e.g., device 108, in a message such as device_registration_response_message, which is protected by encrypting with a public key of the device, in the same or similar fashion other keys are delivered during registration of a service. As described in this example, the authentication key 377 may be used instead of Service Encryption Key (SEK) or Programme Encryption Key (PEK) as the key.

Appender (or combiner) 376 may be configured to append or add the generated MAC to the pricing attribute information. This information can thereafter be transmitted to a second device 110.

As shown in FIG. 3E, an example of pricing attribute extraction module 362 may be provided or employed at a device, such as rights issuer 106, to extract or access or verify the authenticity of protected pricing attribute information as generated in the example shown in FIG. 3D. For example, pricing attribute extraction_module 362 may include authenticate module 379 and MAC generator 378, such as described with reference to FIG. 3D. MAC generator 378 generates a MAC using the received pricing attribute information and the authentication key 377, and authenticate module 379 compares the locally generated MAC with the MAC extracted from the received information in order to authenticate the received pricing attribute information. In this way, it is possible to ascertain whether the pricing attribute information has been tampered with or altered.

### 3. Third Operational Example

FIGS. 3F and 3G are block diagrams of exemplary implementations to protect and extract, respectively, pricing attribute information in accordance with an embodiment. As shown in FIG. 3F, pricing attribute module 360 may include a pricing attribute information generation module 370, an appender 376 and a digital signature generator 380.

As discussed above, pricing attribute information generation module 370 can be configured to generate, update or modify pricing attribute information. This may involve monitoring or evaluating and storing of attributes of received content or content as recorded, such as errors during transmission, quality of the received content or the content as recorded, locality where content is recorded, etc.

Digital signature generator 380 is configured to generate or compute a digital signature using a key, such as a private key 126 of device 108. Digital signature generator 380 may employ a digital signature based authentication method that relies on for example an algorithm such as described in RSA Security Inc. Public-Key Cryptography Standards (PKCS), PKCS #1 (Jun. 14, 2002), which is incorporated by reference in its entirety. If the private key 126 of device 108 is employed, the digital signature can then be verified by using the public key 124 of device 108. However, if such keys are employed, the rights issuer would need to maintain or keep track of public keys of the devices, such as those subscribing to the service, and also all devices that have subscribed in the past, because the request for a right to play a superdistributed recording may come after the subscription has already expired.

Appender (or combiner) 376 may be configured to append or add the generated digital signature to the pricing attribute information. This information can thereafter be transmitted to second device 110.

As shown in FIG. 3G, an example of pricing attribute extraction module 362 may be provided or employed at a device, such as rights issuer 106, to extract or access or verify the authenticity of protected pricing attribute information as generated in the example shown in FIG. 3F. For example, pricing attribute extraction module 362 may include an authenticate module 381. Authenticate module 381 can be configured to verify the received digital signature using the public key 124 of device 108.

### 4. Fourth Operational Example

FIGS. 3H and 3I are block diagrams of exemplary implementations to protect and extract, respectively, pricing attribute information in accordance with an embodiment. The modules 360 and 362 of FIGS. 3H and 3I are similar to that shown in FIGS. 3F and 3G, except that digital certificate or unique device number (UDN), such as of first device 108, is added to the pricing attribute information. For example, in the context of OMA DRM standard(s), the digital certificate or UDN may be incorporated into the RIB. Accordingly, the digital certificate or UDN (e.g., for use to select a digital certificate via database 384) can be used to verify or check that the public key belongs to a trusted party, e.g., device 108. As discussed above for FIGS. 3F and 3G, the public key can then be used to verify the digital signature at the rights issuer.

### 5. Fifth Operational Example

FIGS. 3J and 3K are block diagrams of exemplary implementations to protect and extract, respectively, pricing attribute information in accordance with an embodiment. The modules 360 and 362 of FIGS. 3J and 3K are similar to that shown in FIGS. 3B and 3C, except that the key used to encrypt the pricing attribute information may also be encrypted using another key. That is, multiple levels of encryption may be employed, as desired, for greater protection, and for speed and flexibility of cryptographic operations. Public key algorithms are typically slow, so a commonly used technique is to encrypt the data first with a symmetric algorithm by a randomly generated key, and then protect this symmetric key by the public key. This usually speeds up operations if the amount of data to encrypt is larger than what fits in a single block for the public key cryptoalgorithm.

For example, as shown in FIG. 3J, pricing attribute module 360 may further include an encryption key generator 306 to generate a pricing attribute key, such as a randomly generated key (e.g., a randomly generated symmetric key), which is used to encrypt the pricing attribute information as well as another encryption module 372. The pricing attribute key is also encrypted using the additional encryption module 372 and the public key 152 of first device 108 in order to protect the pricing attribute key 388. Alternatively, the pricing attribute key may be encrypted with the public key 152 of the rights issuer. The key 388, as protected, may be transmitted along with the protected pricing attribute information to device 110, or the rights issuer 106.

Accordingly, in the exemplary environment using the OMA DRM standard(s) (described herein), the RIB includes among other things a content item encryption key (CIEK) used for encrypting the content. The CIEK may be a randomly generated key. The entire RIB may thus be encrypted or encoded as described above using a pricing attribute key in which the pricing attribute key is also encrypted using the public key of the rights issuer. In this example, this pricing attribute key may be one example of or also referred to as a RIB encryption key (RIBEK) when used to encrypt the RIB, and the RIBEK may be encrypted with the public key of the rights issuer as noted above. As such, devices (e.g., second device 110) that subsequently receive the RIB with pricing attribute information and CIEK are not able to modify the protected RIB without corrupting the encrypted CIEK in the process.

As shown in FIG. 3K, in the reverse, pricing attribute extraction module 362 may further include an additional decryption module 373 to decrypt the protected pricing attribute key 388, and the decrypted key 388 may then be used to decrypt the protected pricing attribute information.

A number of protection schemes for pricing attribute information has been described with reference to FIGS. 3B through 3K and are provided simply as examples. Other approaches or combinations involving cryptography and authentication thereof may be employed.

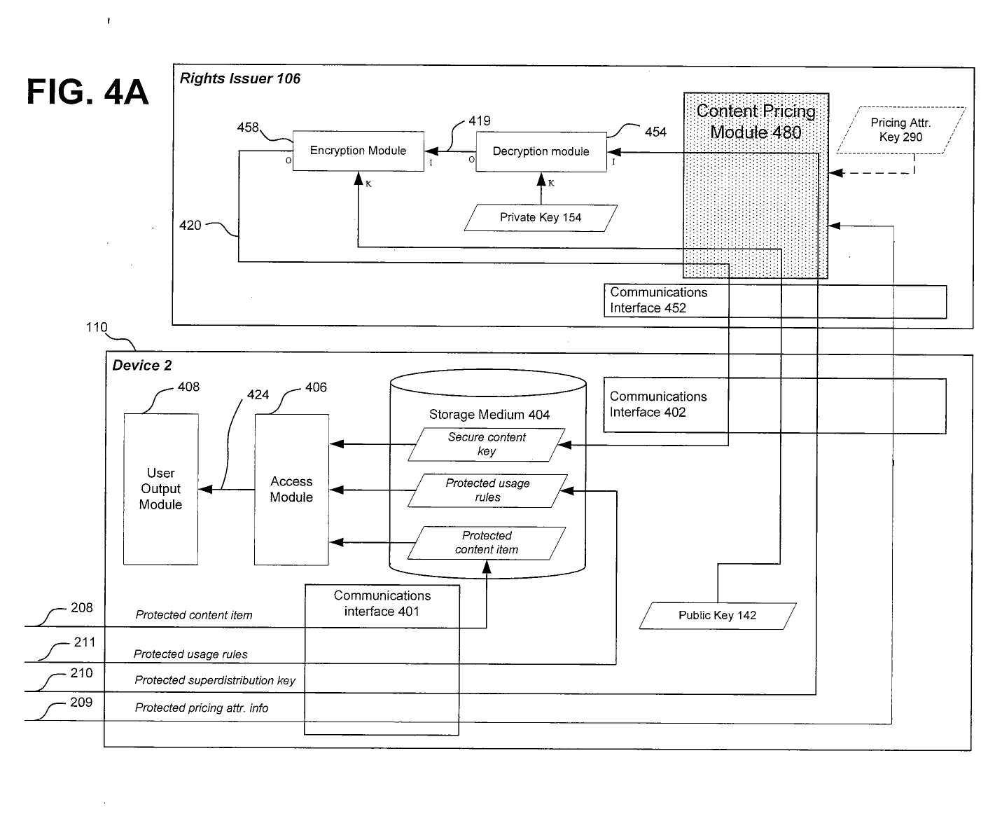

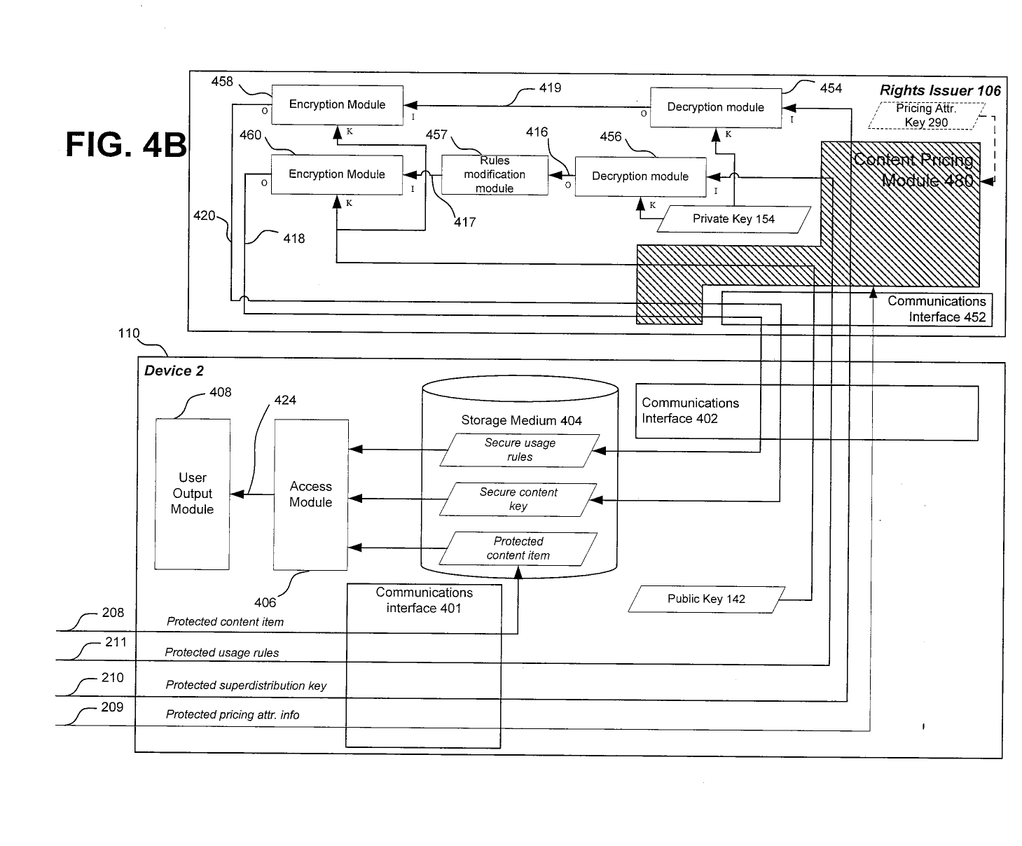

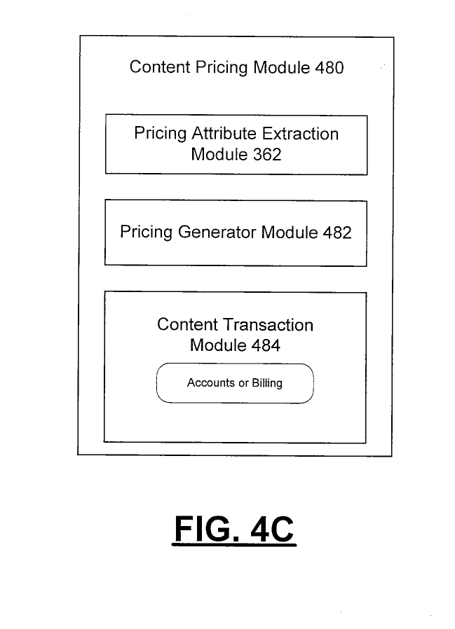

FIGS. 4A, 4B and 4C are block diagrams showing exemplary implementations of second device 110 and rights issuer 106 and components thereof that may be employed in the scenario of FIG. 2. In addition, FIGS. 4A and 4B show interactions between second device 110 and rights issuer 106 according to this scenario.

The second device 110 implementation of FIG. 4A includes communications interfaces 401 and 402, a storage medium 404, an access module 406, and a user output module 408. In various embodiments, second device 110 implementations may have further communications interfaces to provide for the transfer of messaging and content across different communications media.

Communications interface 401 includes hardware and/or software that allow for the reception of transmissions from first device 108. As shown in FIG. 4A, communications interface 401 receives protected content item 208, protected pricing attribute information 209, protected superdistribution key 210, and protected usage rules 211. Interface 401 may forward anyone of this information to storage medium 404 or other communications interfaces.

Storage medium 404 may include random access memory (RAM), read only memory (ROM), flash memory, disk storage, and/or other suitable storage media. As shown in FIG. 4A, storage medium 404 receives and stores protected content item 208 and protected usage rules 211. Protected pricing attribute information 209 may also be stored in storage medium 404 and may be stored along with or as part of the protected content item 208.

Communications interface 402 includes hardware and/or software that allow for the exchange of information with rights issuer 106. Communications interface 402 can receive protected pricing attribute information 209 and protected superdistribution key 210 from storage medium 404 or interface 401. In addition, communications interface 402 may receive public key 142. Communications interface 402 then places this information in an appropriate format for transmission to rights issuer 106 as request 212. Request 212 may comprise one or more transmissions according to various formats and protocols.

Upon receipt of request 212, rights issuer 106 generates a rights object, e.g., a secure content key 420, which is sent to second device 110 as part of response 214. The generation of response 214 is described in greater detail below. As shown in FIG. 4A, communications interface 402 receives secure content key 420 from rights issuer 106 and forwards it to storage medium 404, where it is stored.

Access module 406 may receive protected content item 208, protected usage rules 211, and secure content key 420. FIG. 4A shows access module 406 receiving this information from storage medium 404. However, this information may alternatively be received directly from communications interfaces 401 and 402.

From these received inputs, access module 406 decrypts protected content item 208. In addition, access module 406 may decode or render decrypted content item 208 (i.e., content item 202) into an output signal 424. User output module 408 receives signal 424 and outputs it to a user of second device 110. Implementations of modules 406 and 408 are described in greater detail below with reference to FIG. 14.

The rights issuer 106 implementation of FIG. 4A includes a communications interface 452, a decryption module 454, and an encryption module 458 and a content pricing module 480. Communications interface 452 exchanges information with second device 110, such as request 212 and response 214. Accordingly, communications interface 452 includes hardware and/or software that allow for the exchange of information with second device 110.

As described above, request 212 can include protected pricing attribute information 209 and protected superdistribution key 210. In addition, request 212 may include public key 142. Communications interface 452 forwards protected superdistribution key 210 to decryption module 454.

Decryption module 454 may be implemented in hardware, software, firmware, or in any combination thereof. As shown in FIG. 4A, decryption module 454 has an input interface (indicated with an “I”) for receiving encrypted data, and an input interface (indicated with a “K”) for receiving an encryption key. In addition, decryption module 454 includes an output interface (indicated with an “O”) for outputting decrypted data. Decryption module 454 decrypts protected superdistribution key 210 with private key 154. This produces a decrypted content key 419 (i.e., content key 320), which is sent to encryption module 458.

Encryption module 458 may be implemented as the encryption modules of FIG. 3. FIG. 4A shows that encryption module 458 receives decrypted content key 419 and encrypts it with public key 142. This results in a secure content key 420, which is sent to communications interface 452 for transmission to second device 110 as part of response 214. The processing or transmission of the secure content key 420 or in general access to the requesting party can be made contingent upon payment for the content item. To facilitate such operation, content pricing module 480 is provided. Other information communicated to second device 110 may also be encrypted in a similar fashion using public key 142.

Content pricing module 480 may be implemented in hardware, software, firmware, or in any combination thereof. Content pricing module 480 receives protected pricing attribute information 209, extracts and/or verifies the integrity of the pricing attribute information such as by using a pricing attribute key, some other key or other protection schemes, and determines a price or valuation for an associated content item. Such keys may be generated locally and provided to other parties (such as during registration of a service) to enable encryption of pricing attribute information, or generated and received from some other trusted party such as content distributor 104.

Content pricing module 480 may also conduct transactions or processes involving pricing, negotiations and payment for access to content items. Such transactions may involve additional communications with the access requesting party (e.g., second device 110) to obtain payment information or authorization or automatically charging of an account related or associated with second device 110 or its user. Payment or satisfaction thereof may be implemented in other manners than the above examples. As noted above, upon satisfaction of payment (including agreements to pay), the processing or transmission of a rights object, e.g., secure content key 420 or other access mechanism, is implemented.

FIG. 4B shows further implementations of second device 110 and rights issuer 106 that may be employed in the scenario of FIG. 2. These implementations are similar to the implementations of FIG. 4A. However, the implementations of FIG. 4B, provide for the exchange of usage rules between devices.

As shown in FIG. 4B, communications interface 401 forwards protected usage rules 211 to second communications interface 402. In turn, communications interface 402 formats and sends protected usage rules 211 to rights issuer 106 as part of request 212.

The rights issuer 106 implementation of FIG. 4B includes additional elements to process protected usage rules 211. These additional elements include a decryption module 456, a rules modification module 457 (also referred to as rules module 457), and an encryption module 460.

Decryption module 456 may be implemented as decryption module 454. Decryption module 456 decrypts protected usage rules 211 with private key 154. This produces decrypted usage rules 416 (i.e., usage rules 206), which are sent to rules modification module 457.

Rules modification module 457 may modify decrypted usage rules 416. For example, rules modification module 457 may modify the domain of the corresponding content item. However, such modifications may be limited to modification restrictions included in decrypted usage rules 416. Accordingly, module 457 may be implemented with hardware, software, firmware, or any combination thereof. As shown in FIG. 4B, module 457 generates modified usage rules 417, which are sent to encryption module 460.

Encryption module 460 may be implemented as the encryption modules of FIG. 3. Encryption module 460 encrypts modified usage rules 417 with public key 142. This results in secure usage rules 418, which are sent to communications interface 452. In turn interface 452 transmits secure usage rules 418 to second device 110 as part of response 214.

At second device 110, FIG. 4B shows that communications interface 402 receives and forwards secure usage rules 418 to storage medium 404. Storage medium 404 may then send secure usage rules 418 to access module 406. Alternatively, communications interface 402 may forward secure usage rules 418 directly to access module 406.

FIG. 4C is a block diagram of an exemplary content pricing module 480, such as shown in FIGS. 4A and 4B. Content pricing module 480 may include pricing attribute extraction module 362, pricing generator module 482, and content transaction module 484.

Pricing attribute extraction module 362 is configured to receive protected pricing attribute information and to extract and/or verify the integrity of the information. Various protection schemes may be employed including for example encryption, digital signatures or digital certificates, etc. Exemplary implementations of the module 362 are shown and described above with reference to FIGS. 3C, 3E, 3G, 3I and 3K.

Pricing generator module 482 is configured to determine or calculate a price for access to a content item(s) using associated pricing attribute information. As discussed above, this may involve the use of pricing formulas (e.g., price(base)±price(pricing attributes)), weighting of the price and/or attributes and/or lookup tables or other data tables. Further, the price or valuation for access to a content item may also be dependent on other factors, including for example the type of access requested (e.g., output content, etc.) or the usage rules or limitations, and so forth.

Content transaction module 484 is configured to conduct negotiations or payment transactions with an access requesting party (e.g., second device 110) based on the determined price or valuation. Content transaction module 484 may conduct additional communication with the access requesting party such as to obtain agreement to pay or payment information (e.g., account and authorization to charge account or to bill account) or to negotiate pricing, or may automatically or upon authorization charge an account associated with the requesting party for payment of the determined price or valuation to access the content item. For example, automatic payment may be available for subscribers in a service environment. The price or payment may be monetary or in other forms including goods and services depending on the nature of the parties involved (e.g., commercial transaction, transactions with friends or family, etc.), or other factors.

These various modules and components of content pricing module 480 may be implemented in hardware, software, firmware, or in any combination thereof.

B. Second Scenario

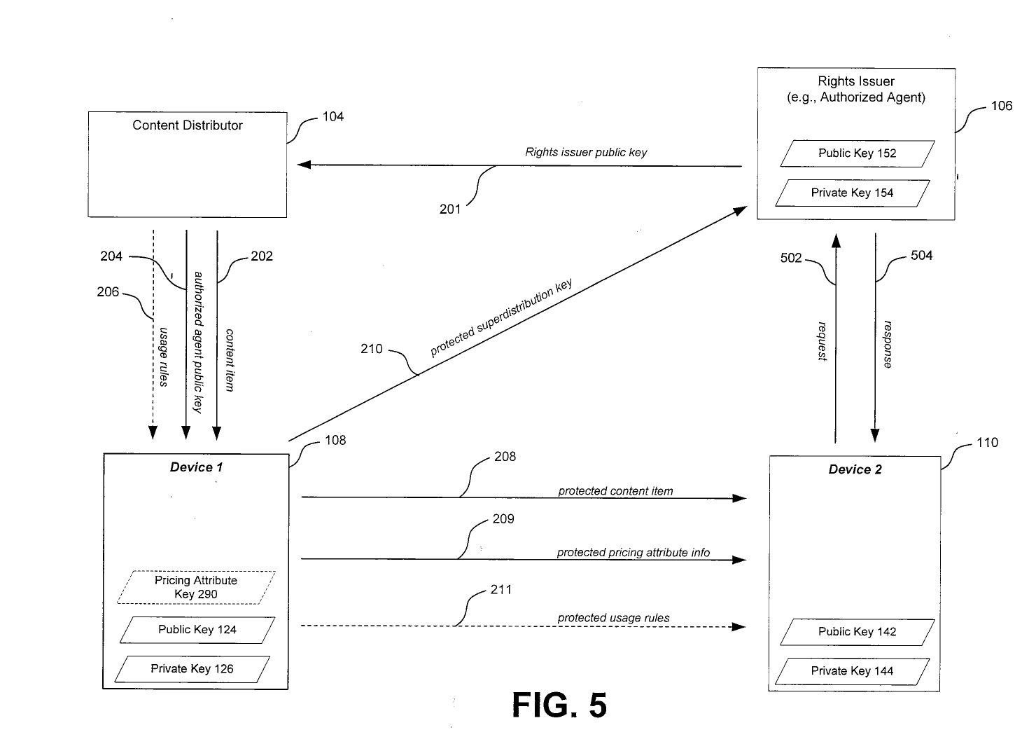

A second content distribution scenario is shown in FIGS. 5-7. This scenario is similar to the first scenario described above with reference to FIGS. 2-4. For instance, content distributor 104 receives a transmission 201 from rights issuer 106 that includes public key 152. Also, content distributor 104 transmits to first device 108 content item 202, encryption key 204, and usage rules 206.

First device 108 receives this information and generates protected content item 208, protected pricing attribute information, protected superdistribution key 210, and protected usage rules 211 in the manner described above with reference to FIGS. 2-4. The pricing attribute information may be protected using pricing attribute key 290 generated locally or obtained from a trusted remote location or party. As in the first scenario, protected content item 208, protected pricing attribute information 209, and protected usage rules 211 are sent to second device 110. However, unlike the first scenario of FIGS. 2-4, first device 108 sends protected superdistribution key 210 to rights issuer 106, instead of to second device 110. This key is sent to rights issuer 106 across a network. This network may be one of networks 120, 122, 124, and 126.

After receiving protected content item 208 and protected pricing attribute information 209, second device 110 may transmit a content key request 502 to rights issuer 106. Request 502 may include information that identifies the particular content item that corresponds to the requested content key. In addition, request 502 may include protected pricing attribute information 209 or information therefrom, and/or public key 142 of second device 110.

In response to request 502, rights issuer 106 determines a pricing or value for the content item based on the pricing attribute information 209 and conducts a transaction for payment by second device 110 or its user of the determined price or value before access to the content item 208 is allowed or authorized. The transaction may involve additional communications between the rights issuer 106 and second device 110 to obtain payment information or authorization or automatically charging of an account related or associated with second device 110 or its user. Payment or satisfaction thereof may be implemented in other manners than the above described examples.

Upon satisfaction of the payment, rights issuer 106 generates a response 504. Rights issuer 106 then sends response 504 to second device 110. Response 504 includes a rights object, e.g., a secure content key. This secure content key is the content key generated by first device 108, but encrypted with public key 142 of second device 110.

At this point, second device 110 may decrypt the secure content key from response 504 with private key 144 to obtain the key used by first device 108 when encrypting protected content item 208. With this content key, second device 110 may decrypt and access the underlying content of protected content item 208.

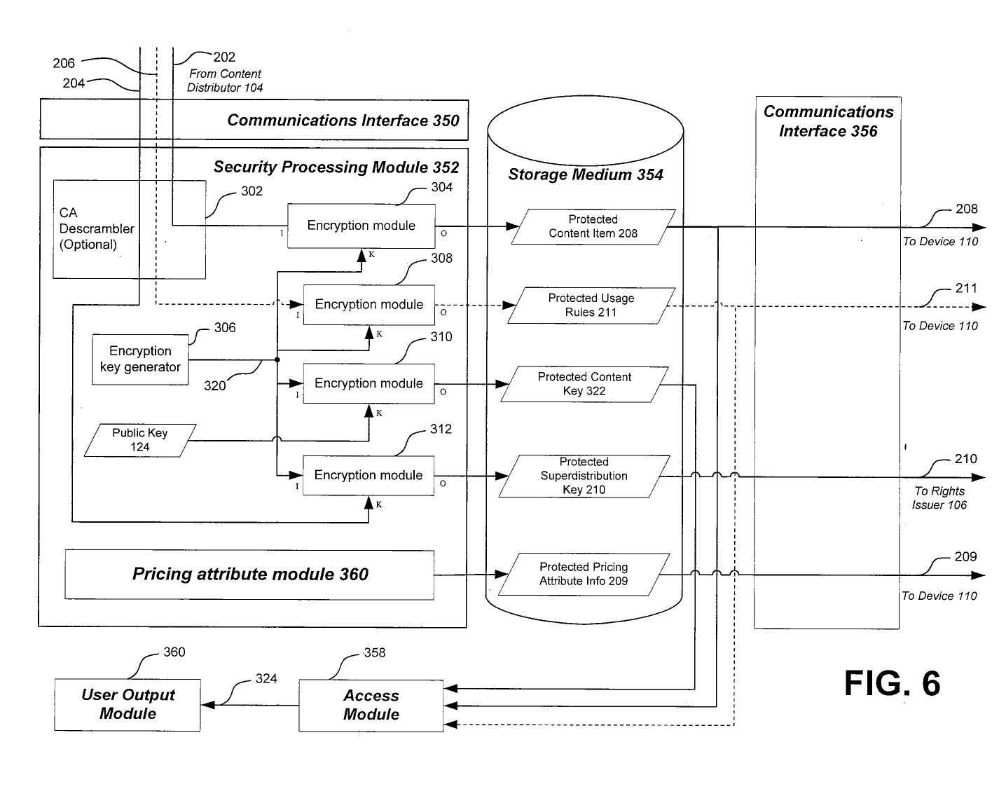

FIG. 6 is a block diagram of an exemplary first device 108 implementation that may be employed in the scenario of FIG. 5. This implementation is similar to the implementation of FIG. 3. However, instead of sending protected superdistribution key 210 to second device 110, second communications interface 356 sends protected superdistribution key 210 to rights issuer 106. Thus, in the implementation of FIG. 6, interface 356 allows for the transmission of information to both second device 110 and rights issuer 106.

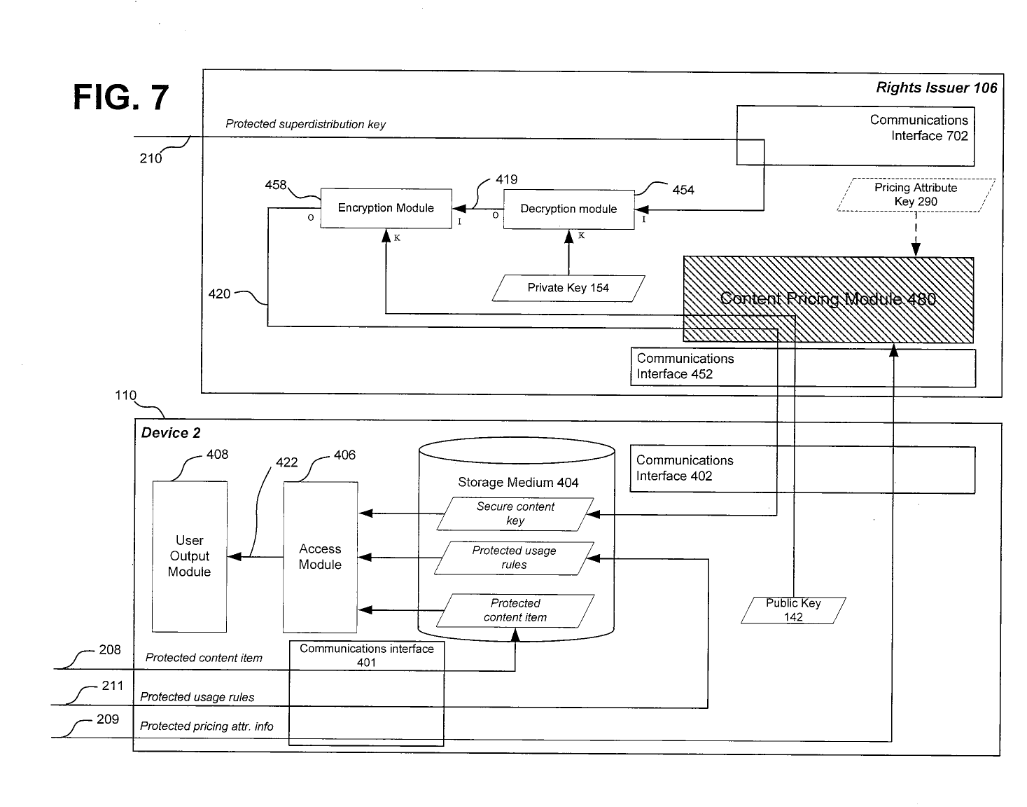

FIG. 7 is a block diagram showing exemplary implementations of second device 110 and rights issuer 106 that may be employed in the scenario of FIG. 5. In addition, FIG. 7 shows interactions between second device 110 and rights issuer 106 according to this scenario.

The implementations of FIG. 7 are similar to the implementations of FIG. 4A. However, in FIG. 7, protected superdistribution key 210 is not sent from second device 110 to rights issuer 106. Instead, rights issuer 106 receives protected superdistribution key 210 from first device 108 via a communications interface 702. Communications interface 702 provides for the exchange of information between first device 108 and rights issuer 106. Interface 702 may be implemented in hardware, software, firmware, or any combination thereof.

Decryption module 454 decrypts protected superdistribution key 210 with private key 154. This produces a decrypted content key 419 (i.e., content key 320). Encryption module 458 encrypts decrypted content key 419 with public key 142. Public key 142 may be sent to rights issuer 106 as part of request 502. This encryption produces secure content key 420, which is sent to communications interface 452 for transmission to second device 110 as part of response 504.

C. Third Scenario

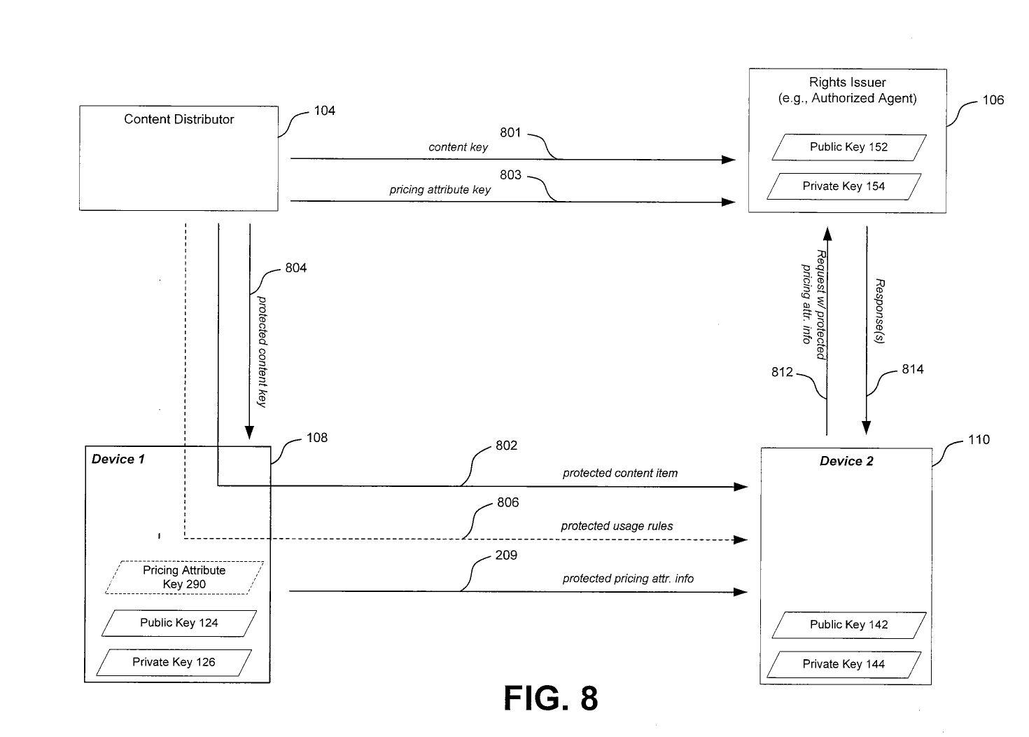

A third content distribution scenario is shown in FIGS. 8-10. In this scenario, content distributor 104 sends a content key 801 to rights issuer 106. Also, content distributor 104 sends to first device 108 a protected content item 802, and a protected content key 804. In addition, content distributor 104 may also send protected usage rules 806 to first device 108. Protected content item 802, protected content key 804, and protected usage rules 806 are each encrypted with content key 801.

As shown in FIG. 8, first device 108 forwards protected content item 802, protected pricing attribute information 209 and protected usage rules 806 to second device 110. However, upon receipt of this information, second device 110 cannot decrypt protected content item 802 and protected usage rules 806, because it does not have access to a necessary encryption key. Accordingly, for second device 110 to decrypt this information, it relies on rights issuer 106.

More particularly, upon receipt of protected content item 802 and protected usage rules 806, second device 110 may send a content key request 812 to rights issuer 106. Request 812 may include an encryption key associated with second device 110, such as public key 142. In addition, request 812 may include protected pricing attribute information or information therefrom, and information identifying the particular content item that corresponds to the requested content key.

In response to request 812, rights issuer 106 determines a pricing or value for the content item based on the pricing attribute information 209 and conducts a transaction for payment by second device 110 or its user of the determined price or value before access to the content item 208 is allowed or authorized. The transaction may involve additional communications between the rights issuer 106 and second device 110 to obtain payment information or authorization or automatically charging of an account related or associated with second device 110 or its user. Payment or satisfaction thereof may be implemented in other manners than the above described examples.

Upon satisfaction of the payment, rights issuer 106 generates a response 814 and sends it to second device 110. Response 814 includes a content key encrypted with a key that is specific to second device 110, (e.g., public key 142). At this point, second device 110 may decrypt protected content item 208.

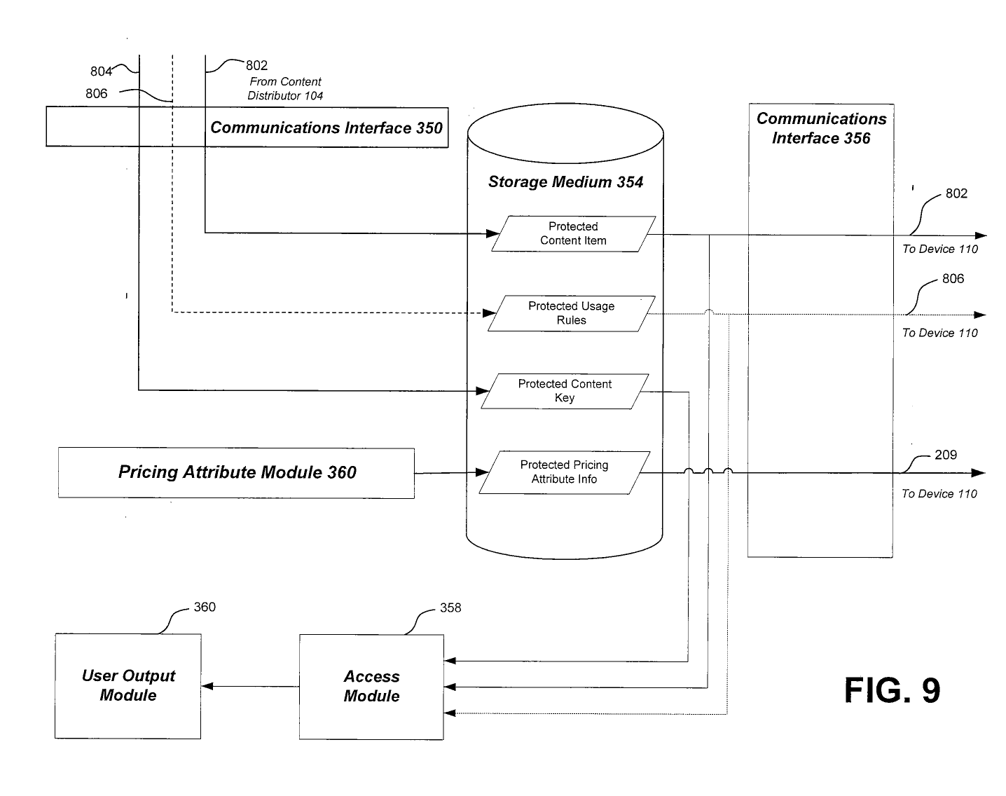

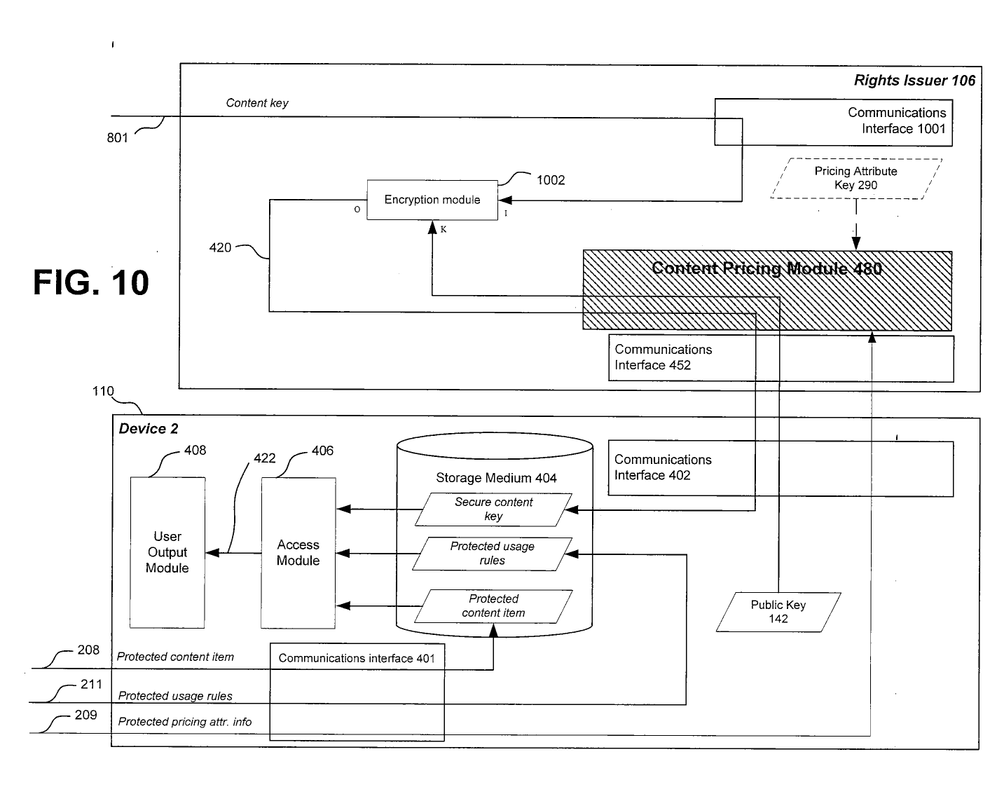

FIG. 9 is a block diagram of an exemplary first device 108 implementation that may be employed in the scenario of FIG. 8. This implementation is similar to the implementation of FIG. 3. However, this implementation does not include a security processing module 352 but still includes a pricing attribute module 360. This is because protected content item 802, protected content key 804, and protected usage rules 806 are received from content distributor 104 in a protected format. More particularly, this information is encrypted with a key associated with first device 108, such as public key 124.

Accordingly, FIG. 9 shows first communications interface 350 sending protected content item 802, protected content key 804, and protected usage rules 806 to storage medium 354. In addition, FIG. 9 shows storage medium 354 sending protected content item 802, protected pricing attribute information 209, and protected usage rules 806 to second communications interface 356 for transmission to second device 110. However, in alternative implementations, this information may be sent directly from first communications interface 350 to second communications interface 356 if the information is received through the interface 350.

FIG. 10 is a block diagram showing exemplary implementation of second device 110 and rights issuer 106 that may be employed in the scenario of FIG. 8. In addition, FIG. 10 shows interactions between second device 110 and rights issuer 106 according to this scenario.

The implementations of FIG. 10 are similar to the implementations of FIG. 4A. However, in FIG. 10, protected superdistribution key 210 is not sent from second device 110 to rights issuer 106. Instead, rights issuer 106 receives content key 801 from first device 108 via a communications interface 1001. Communications interface 1001 provides for the exchange of information between first device 108 and rights issuer 106. Interface 1001 may be implemented in hardware, software, firmware, or any combination thereof.

Within rights issuer 106, an encryption module 1002 encrypts content key 801 with public key 142. As shown in FIG. 10, public key 142 may be sent to rights issuer 106 as part of request 812. This encryption produces secure content key 420, which is sent to communications interface 452 for transmission to second device 110 as part of response 814 upon satisfaction of payment through content pricing module 480, similarly as in the above described exemplary embodiments.

D. Fourth Scenario

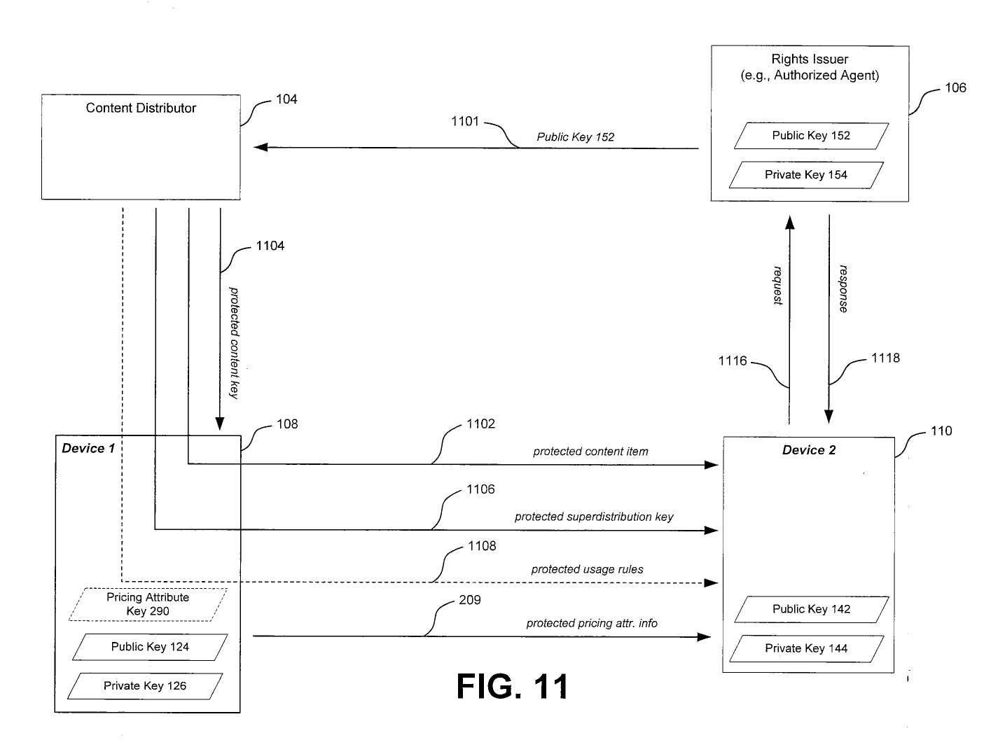

A fourth content distribution scenario is shown in FIGS. 11-13. In this scenario, rights issuer 106 sends its public key 152 to content distributor 104 in a transmission 1101. Content distributor 104 sends to first device 108 a protected content item 1102, a protected content key 1104, and a protected superdistribution key 1106. As shown in FIG. 11, content distributor 104 may also send to first device 108 protected usage rules 1108.

Protected content item 1102 and protected usage rules 1108 are encrypted with a content key that is generated or provided by content distributor 104. This content key is encrypted with public key 124 to produce protected content key 1104. In addition, this content key is also encrypted with public key 152 to produce protected superdistribution key 1106.

As shown in FIG. 11, first device 108 may send protected content item 1102, protected pricing attribute information 209, protected superdistribution key 1106, and protected usage rules 1108 to second device 110. However, upon receipt of this information, second device 110 cannot decrypt protected content item 1102 and protected usage rules 1108, because it does not have access to a necessary encryption key. Accordingly, for second device 110 to decrypt this information, it relies on rights issuer 106.

Second device 110 transmits a content key request 1116 to rights issuer 106. Request 1116 includes protected pricing attribute information 209, and protected superdistribution key 1106. In addition, request 1116 may include an encryption key associated with second device 110, such as public key 142.

In response to request 1116, rights issuer 106 determines a pricing or value for the content item based on the pricing attribute information 209 and conducts a transaction for payment by second device 110 or its user of the determined price or value before access to the content item 208 is allowed or authorized. The transaction may involve additional communications between the rights issuer 106 and second device 110 to obtain payment information or authorization or automatically charging of an account related or associated with second device 110 or its user. Payment or satisfaction thereof may be implemented in other manners than the above described examples.

Upon satisfaction of the payment, rights issuer 106 generates a response 1118 and sends it to second device 110. Response 1118 includes a rights object, e.g., a secure content key. This secure content key is the content key used by content distributor to produce protected content item 1102, but it is encrypted with public key 142 of second device 110.

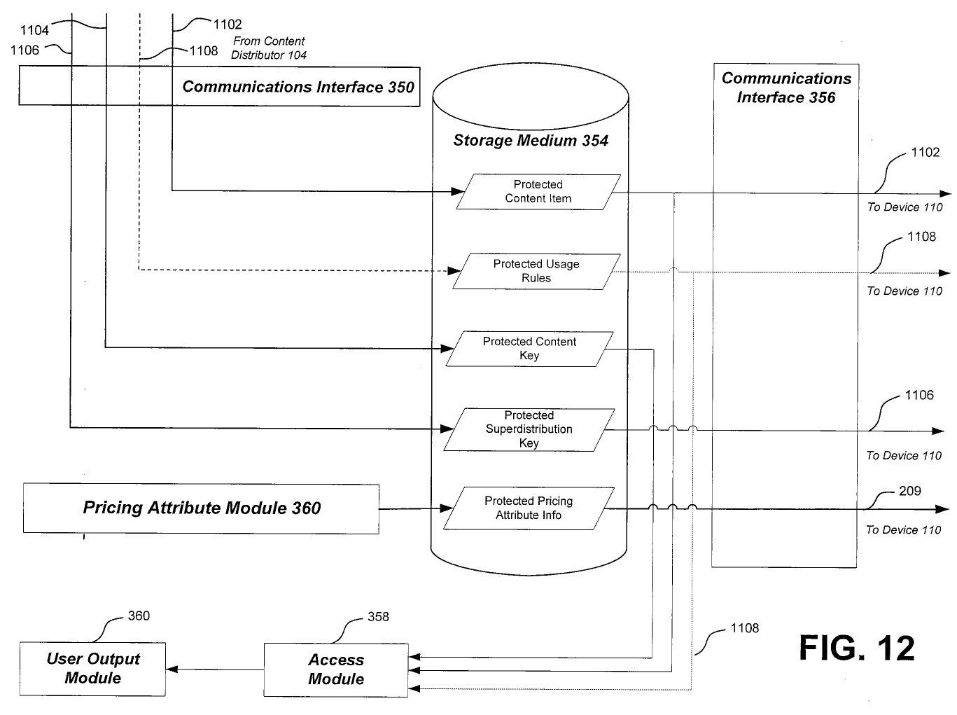

FIG. 12 is a block diagram of an exemplary first device 108 implementation that may be employed in the scenario of FIG. 11. This implementation is similar to the implementation of FIG. 9 in that it does not include a security processing module 352, but does include pricing attribute module 360. However, unlike the implementation of FIG. 9, communications interface 350 receives protected superdistribution key 1106 from content distributor 104 and forwards it to storage medium 354.

As shown in FIG. 12, storage medium 354 sends protected content item 1102, protected pricing attribute information 209, protected superdistribution key 1106, and protected usage rules 1108 to second communications interface 356 for transmission to second device 110. However, in alternative implementations, this information may be sent directly from first communications interface 350 to second communications interface 356 if the information is received at the interface 350.

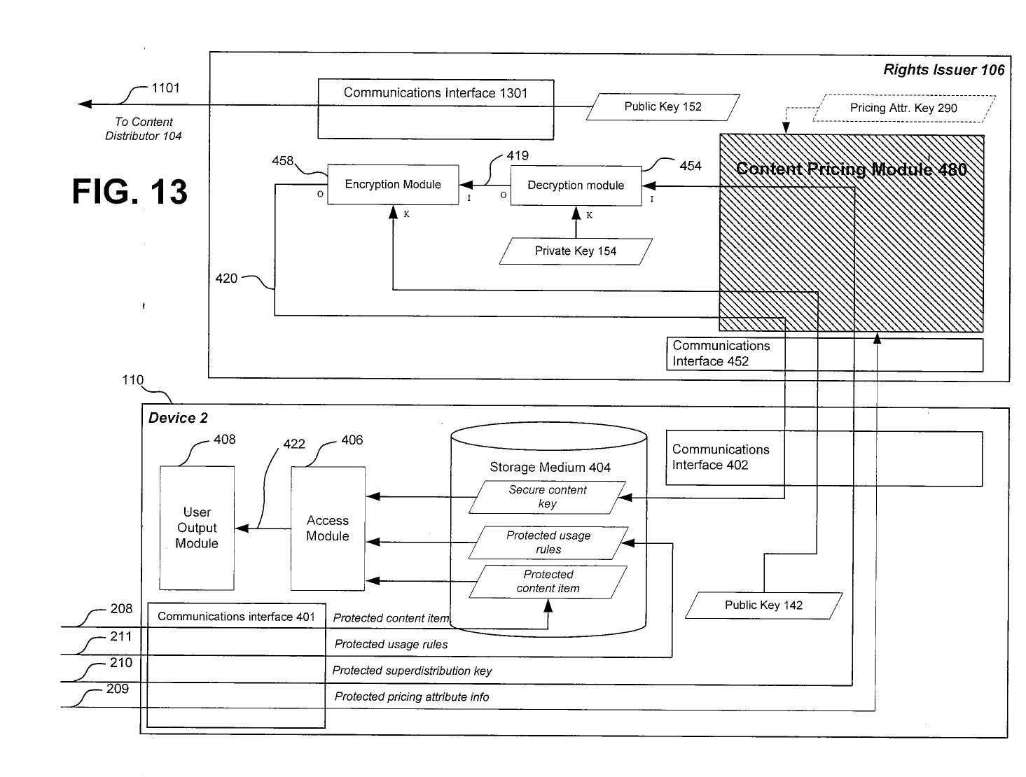

FIG. 13 is a block diagram showing exemplary implementations of second device 110 and rights issuer 106 that may be employed in the scenario of FIG. 11. In addition, FIG. 13 shows interactions between second device 110 and rights issuer 106 according to this scenario.

The implementations of FIG. 13 are similar to the implementations of FIG. 4A. However, in FIG. 13, the implementation of rights issuer 106 includes a communications interface 1301. Communications interface 1301 provides for the exchange of information between rights issuer 106 and content distributor 104. This interface may be implemented in hardware, software, firmware, or any combination thereof. As shown in FIG. 13, communications interface 1301 sends public key 152 to content distributor 104 in the form of transmission 1101.

E. Further Scenarios

Although four scenarios have been described above, other scenarios are within the scope of the present invention(s). For instance, as described above with reference to FIG. 3, content distributor 104 may employ conditional access (CA) protection in transmitting information to first device. However, the other scenarios may also employ CA protection. In addition, other scenarios may allow for rights issuer 106 to receive and modify usage rules, as described above with reference to FIG. 4B. Also, while the above scenarios describe usage rules being transferred and processed. These usage rules may be included in vouchers.

Moreover, in scenarios where content distributor 104 transmits CA protected content or pricing attribute information, first device 108 may process the content or information and transfer it to second device 110, without descrambling it. This results in a double encryption feature. Accordingly, to process such double encrypted information, implementations of second device 110 and rights issuer 106 may have descrambling capabilities and receive CA encryption keys from content distributor 104.

Also, in the scenarios described above, the content key is encrypted with public key 124 of first device 108 to produce a protected content key. However, the content key may alternatively be encrypted with a domain key. Thus, if device 110 belongs to the same domain as first device 108, it may receive this encrypted content key and decrypt it without ever receiving a superdistribution key or engaging in communications with a rights issuer. However, if second device 110 does not belong to the same domain as first device 108, it may employ the techniques described above to obtain the content key. This similar approach may also be employed to protect pricing attribute information.

F. Digital Certificates

The scenarios described above and herein involve the transfer and use of secret information, such as content and pricing attribute keys. To ensure that such secret information is encrypted with a public key, the public keys of devices, such as rights issuer 106 and second device 110, may be transferred to other devices in digital certificates. This verifies that the public keys belong to these devices and establishes these devices as trusted entities.

The devices in the above scenarios may employ a certificate authority (not shown) to embed their public keys in a digital certificate. In embodiments, the certificate authority creates such certificates by encrypting a device's public key (as well as other identifying information) such that it may be decrypted using the certificate authority's public key. This public key is publicly available (e.g., through the Internet). When a device receives a digital certificate, it may obtain the sender's public key by decrypting certificate with the certificate authority's public key.

### III. Access and Output Modules

As described above, first device 108 and second device 110 may each include an access module and a user output module. An example of these modules is shown in FIG. 14.

As shown in FIG. 14, an access module 1402 includes decryption modules 1414, 1416, and 1418. In addition, access module 1402 includes a rendering engine 1420 coupled to decryption modules 1416 and 1418. These elements may be implemented in hardware, software, firmware, or in any combination thereof.

Each of decryption modules 1414, 1416, and 1418 has an input interface (indicated with an “I”) for receiving encrypted data, and an input interface (indicated with a “K”) for receiving an encryption key. In addition, each of these modules includes an output interface (indicated with an “O”) for outputting decrypted data.

Access module 1402 receives secure content key 1406, protected content item 1408, and protected usage rules 1410. Secure content key 1406 is a content key encrypted with a public key of the device in which access module 1402 is implemented. As shown in FIG. 14, decryption module 1414 decrypts secure content key 1406 with a corresponding private key 1412 of the device in which access module 1402 is implemented. This decryption produces a content key 1407.

FIG. 14 shows that decryption module 1416 receives protected content item 1408 and content key 1407 to generate content item 1450. Decryption module 1418 receives protected usage rules 1410 and content key 1407 to generate usage rules 1452. This generation may be based on symmetric encryption techniques, since content key 1407 may have also been used to generate protected content item 1408, and protected usage rules 1410.

Content item 1450 and usage rules 1452 are sent to rendering engine, where content item is decoded or rendered into an output signal 1454. This decoding or rendering is subject to any restrictions or conditions of usage rules 1452.

FIG. 14 shows that user output module 1404 may include one or more displays 1422, and one or more speakers 1424 for outputting signal 1454 to a user. However, user output module 1404 may include other devices, as would be apparent to persons skilled in the relevant arts.

### IV. Process

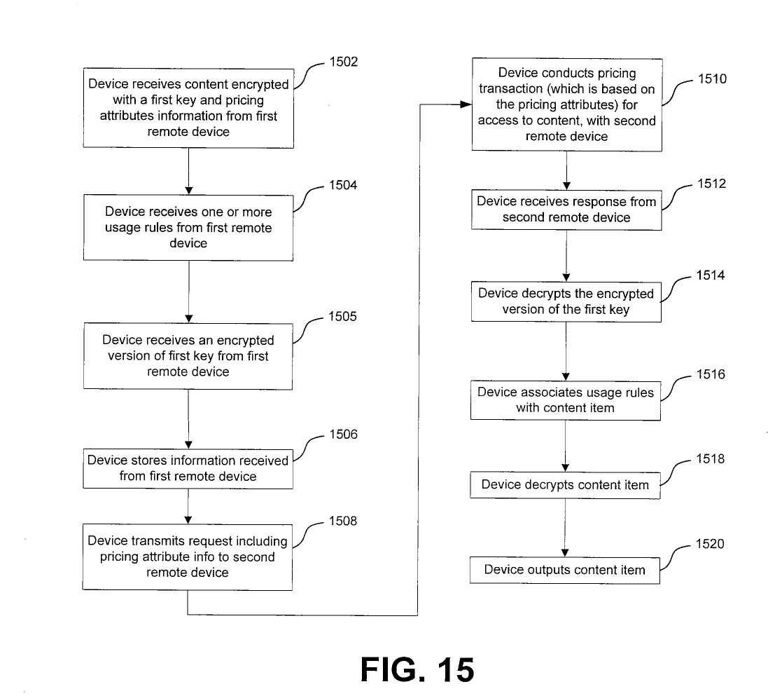

FIG. 15 is a flowchart of a process according to an embodiment. Examples of this process are described above with reference to FIGS. 2-13. However, this process may be performed in other environments, topologies, and scenarios.

As shown in FIG. 15, this process includes a step 1502. In this step, a device, such as second device 110, receives content from a first remote device, such as first device 108. Accordingly, this device is referred to herein as “the content receiving device.” This received content is encrypted with a first encryption key.

The process of FIG. 15 may include optional steps 1504 and 1505. In optional step 1504, the content receiving device may receive one or more usage rules from the first remote device. These usage rules may be expressed in a voucher. Like the content received in step 1502, the one or more received usage rules are encrypted with the first encryption key. In optional step 1505, the content receiving device may receive an encrypted version of the first encryption key from the first remote device. If received, this encrypted version may be encrypted with a key corresponding to a second remote device, such as an rights issuer. For example, this key may be a public key of the second remote device.

In an optional step 1506, the content receiving device may store the content received in step 1502, as well as any usage rules received in step 1504 (if performed) and pricing attribute information. Also, the content receiving device may store the encrypted version of the first key received in step 1505 (if performed). Although FIG. 15 shows step 1506 following step 1502, 1504, and 1505, this step may be performed in other sequences.

In a step 1508, the content receiving device transmits a request for the first encryption key to the second remote device. The request may include the pricing attribute information and a second encryption key. This second encryption key may be associated with the content receiving device. For instance, the second encryption key may be a public key of the content receiving device.

The request transmitted in step 1508 may also include other information. For instance, if optional step 1504 is performed, the request may include the one or more encrypted usage rules received in that step. These usage rules may be expressed in a voucher. Similarly, if optional step 1505 is performed, the request may include the encrypted version of the first encryption key received in that step.

At step 1510, the content receiving device may conduct a pricing transaction based on the sent pricing attribute information and the price or value for access determined therefrom.

A step 1512 follows step 1510. In this step, the content receiving device receives a response from the second remote device such as upon satisfaction the pricing transaction (e.g., payment of the price). This response includes an encrypted version of the first encryption key. This encrypted version is encrypted with the second encryption key. As described above with reference to step 1508, this second encryption key may be associated with the content receiving device. For instance, the second encryption key may be a public key of the content receiving device.

If the request of step 1508 included one or more encrypted usage rules, then the response received in step 1512 may also include one or more usage rules. These usage rules may expressed in a voucher. In addition, these usage rules may be encrypted with a key associated with the content receiving device, such as its public key. These received usage rules may have been modified by the second remote device.

In a step 1514, the content receiving device decrypts the encrypted version of the first encryption key with a third encryption key. The third encryption key corresponds to the second encryption key. In embodiments, the second and third encryption keys may be associated with the content receiving device. For example, the second encryption key may be a public key of the content receiving device and the third encryption key may be a private key of the content receiving device.

After step 1514 is performed, the content receiving device may perform optional steps 1516, 1518 and 1520.

Step 1516 may be performed when the response received in step 1512 includes one or more usage rules. In step 1516, the content receiving device associates the usage rules received in step 1512 with the content received in step 1502. This step may include decrypting the usage rules (or voucher) with a key that corresponds to the key in which the received usage rules are encrypted. The key used for this decryption may be the private key of the content receiving device. Once decrypted, may access any data in the usage rules (or voucher) which identifies the corresponding content item.

In step 1518, the content receiving device decrypts the content received in step 1502 with the first content key decrypted in step 1514. In optional step 1520, the content receiving device outputs the content decrypted in step 1518 to a user of the content receiving device.

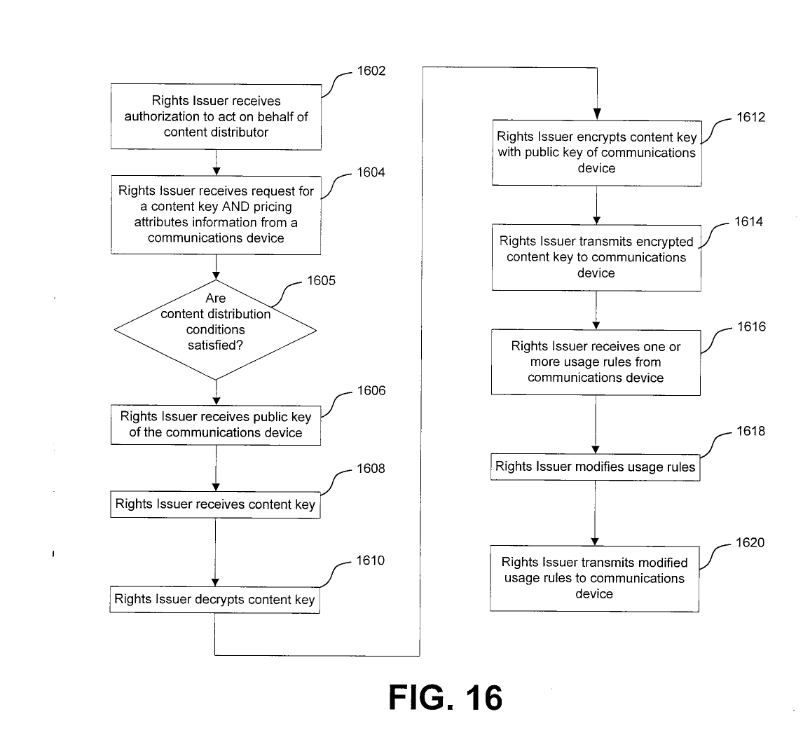

FIG. 16 is a flowchart of an operational sequence that may be performed by a device, such as rights issuer 106. This sequence includes multiple steps, which may be performed in a variety of orders. Also, modifications to this sequence, such as the performance of additional steps, may be made.

In a step 1602, the rights issuer receives authorization to act on behalf of a content distributor, such as content distributor 104. For example, this step may include the rights issuer receiving an authorization message from the content distributor via a network, such as network 126. Accordingly, the rights issuer may include a communications interface (such as communications interfaces 702 and 1001) for exchanging information with the content distributor.

In a step 1604, the rights issuer receives a request for a rights object, e.g., a content key, from a communications device, such as device 110. The request may include pricing attribute information. Next, in a step 1605, the rights issuer determines whether one or more one or more content distribution conditions are satisfied. An example of such a condition includes determination of a price or value for access based on pricing attribute information and receipt or satisfaction or agreement of a payment from the communications device. If such conditions are satisfied, operation proceeds to a step 1606.

In step 1606, the rights issuer receives a public key of the communications device. This key may be received from the communications device. For example, this public key may be received as part of the request of step 1604.

In a step 1608, the rights issuer receives the content key in an encrypted form. This encrypted content is encrypted with a public key of the rights issuer. The rights issuer may receive this key from the communications device. For example, this content key may be received as part of the request of step 1604. Alternatively, this content key may be received from other devices, such as the content distributor.

In a step 1610, the rights issuer decrypts the content key encrypted with the public key of the rights issuer. In a step 1612, the rights issuer encrypts the content key with a public key of the communications device.

A step 1614 follows step 1612. In this step, the rights issuer transmits the content key encrypted in step 1612 to the communications device.

As described above, there can be provided the modification of usage rules. Accordingly, in a step 1616, the rights issuer may receive one or more usage rules from the communications device. These usage rules correspond to the content item.

In a step 1618, the rights issuer modifies the usage rule(s) received in step 1616. Such modifications may be subject to one or more modification limitations. Examples of modification limitations include temporal limitations that permit modification only during a specified time interval, content type limitations that permit usage rule modifications for only certain types of content (e.g., video broadcasts), and specific limitations that permit usage rule modifications for only particular content items. Such modification limitations may be received from the content distributor, for example, in the authorization of step 1602.

When received, the one or more usage rules may be encrypted with the public key of the rights issuer. Accordingly, step 1618 may also include decrypting the usage rules with the corresponding private key of the rights issuer.

In a step 1620, the rights issuer transmits the modified usage rule(s) to the communications device. These modified usage rules may be encrypted with the public key of the communications device. Thus, step 1618, may include encrypting these modified usage rules with the public key of the communications device.

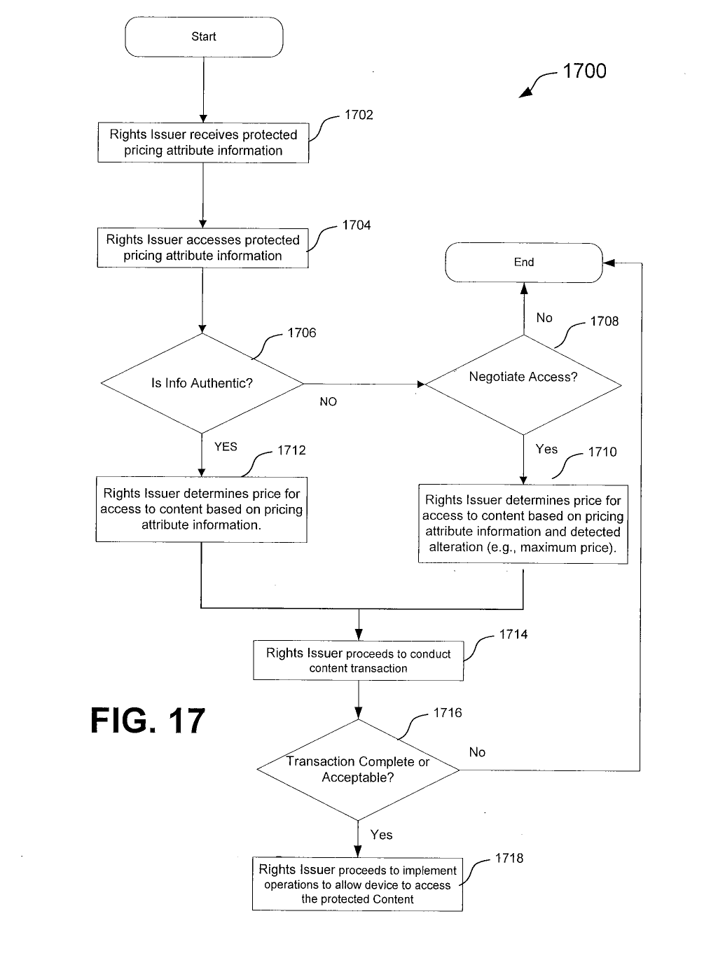

FIG. 17 is a flowchart of an operational sequence or process 1700 that may be performed by a device, such as rights issuer 106. This sequence includes multiple steps, which may be performed in a variety of orders. Also, modifications to this sequence, such as the performance of additional steps, may be made.

As shown in FIG. 17, the process 1700 begins with the rights issuer receiving protected pricing attribute information at step 1702. In step 1704, the rights issuer accesses protected pricing attribute information. This may involve for example decryption; validation of MAC, digital certificate or digital signature or unique device number (UDN); and so forth. At step 1706, the rights issuer determines whether the pricing attribute information is authentic or has been altered (e.g., such as impermissibly or illegally altered). If authentic or not altered, the rights issuer determines a price or valuation for access to the associated content item based on the pricing attribute information.

If altered or not authentic, the rights issuer determines whether to continue with negotiation or transaction for access of the content item at step 1708. If not, the process 1700 terminates. Otherwise, at step 1710, the rights issuer determines a price or valuation for access to the corresponding content item based on the pricing attribute information and/or detected alteration or tampering. For example, the price or valuation may be increased above, for example, the determined price or value in step 1712 or to a maximum price or value.

In any event, from steps 1712 or 1710, the rights issuer proceeds to conduct the transaction for access to the content item. For example, this may involve a payment transaction with the access requesting party at the determined price or value. At step 1716, the rights issuer determines whether the transaction is successfully completed or acceptable. If the transaction is not successful or no agreement is reached, the process 1700 is terminated. Otherwise, at step 1718, the rights issuer proceeds to implement the operations or processes to enable the access requesting party to access the protected content item, such as described herein in the various embodiments.

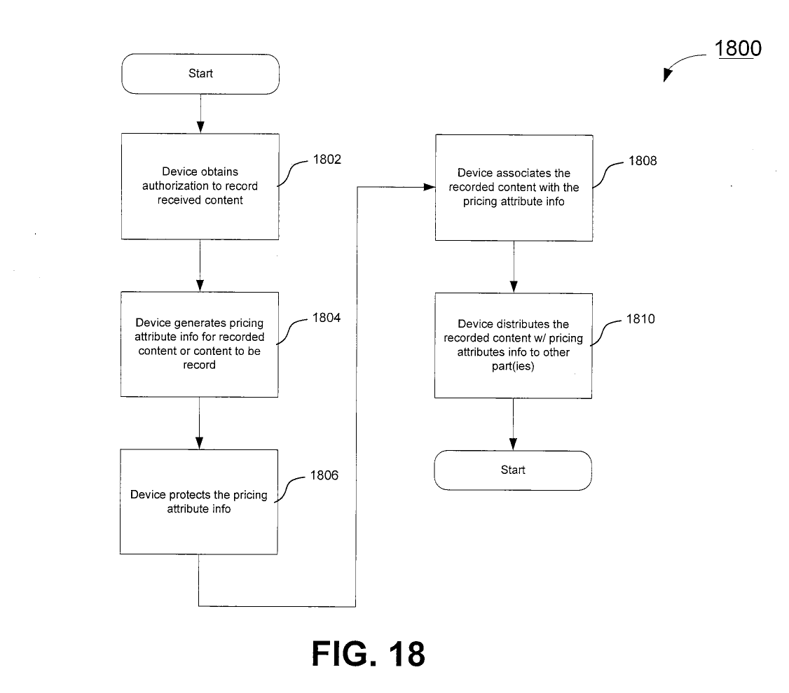

FIG. 18 is a flowchart of an operational sequence or process 1800 that may be performed by a device, such as first device 108 or any device authorized to record content (e.g., content item). This sequence includes multiple steps, which may be performed in a variety of orders. Also, modifications to this sequence, such as the performance of additional steps, may be made.

At step 1802, the device obtains authorization to record received content, such as content received from a content distributor through a service. In step 1804, the device generates, updates or modifies pricing attribute information for recorded content or content to be recorded. At step 1806, the device protects the pricing attribute information. For example, the device may implement encryption or validate the information with digital certificate, digital signature, or unique device number (UDN) of a trusted device or so forth.

At step 1808, the device associates the recorded content with the pricing attribute information. For example, the pricing attribute information may be incorporated into the pricing attribute information, bundled together as separate files, incorporated into header information of the recorded content or formatted or configured in other manners to retain association between the pricing attribute information and the recorded content when distributed. At step 1810, the device distributes the recorded content with pricing attribute information to other part(ies). In accordance with various embodiments, these other parties may then communicate with a rights issuer to obtain access to the recorded content.

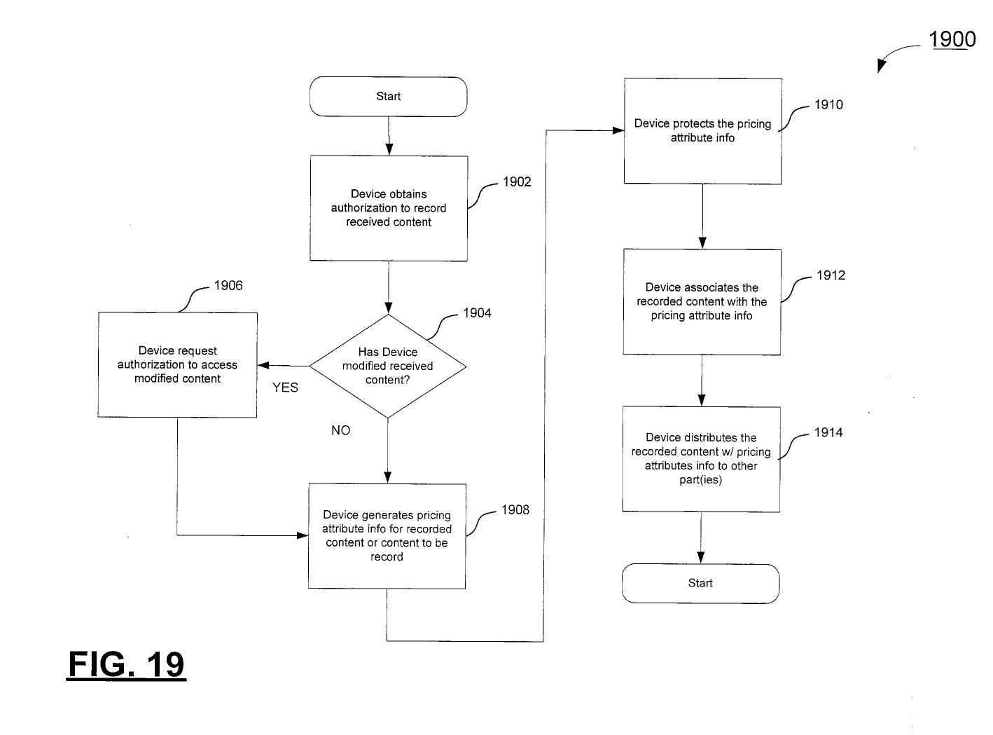

FIG. 19 is a flowchart of an operational sequence or process 1900 that may be performed by a device, such as first device 108 any device authorized to record content. This sequence includes multiple steps, which may be performed in a variety of orders. Also, modifications to this sequence, such as the performance of additional steps, may be made.

As shown in FIG. 19, in step 1902, the device obtains authorization to record received content, such as from a content distributor. At step 1904, a determination is made on whether the received content has been modified by the device. If so, the device requests authorization to access the modified content at step 1906.

Irrespective of whether the content has been modified, at step 1908, the device generates, updates or modifies pricing attribute information for recorded content or content to be recorded. At step 1910, the device protects the pricing attribute information.

At step 1912, the device associates the recorded content with the pricing attribute information. For example, the pricing attribute information may be encoded into a block, segment or field of a header of the recorded content, maintained as a separate item from the recorded content, bundled together as separate items, etc. This information as described in the various embodiments may be protected prior to distribution or transmission of the recorded content and pricing attribute information to other parties. At step 1914, the device distributes or transmits or broadcasts the recorded content with the pricing attribute information to other parties.

### V. Computer System

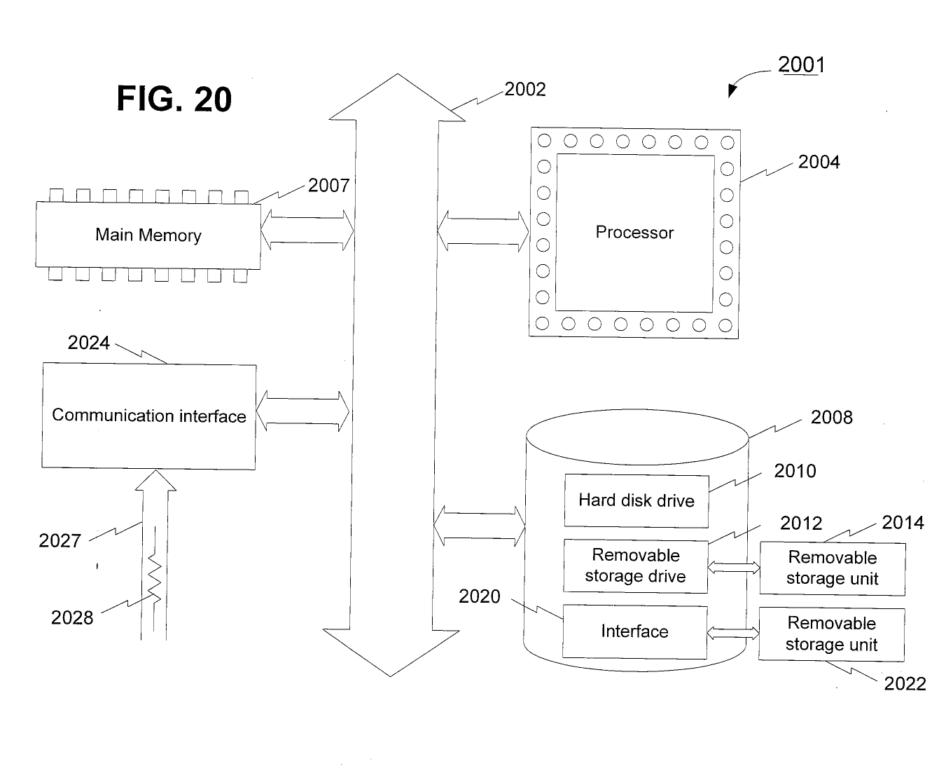

As described above, devices 104, 106, 108, and 110 may include software components. Accordingly, these devices may be implemented with one or more computer systems. An example of a computer system 2001 is shown in FIG. 20. Computer system 2001 represents any single or multi-processor computer. Single-threaded and multi-threaded computers can be used. Unified or distributed memory systems can be used.

Computer system 2001 includes one or more processors, such as processor 2004. One or more processors 2004 can execute software implementing the functionality described above. Each processor 2004 is connected to a communication infrastructure 2002 (for example, a communications bus, cross-bar, or network). Various software embodiments are described in terms of this exemplary computer system. After reading this description, it will become apparent to a person skilled in the relevant art how to implement the features and functions as described herein using other computer systems and/or computer architectures.

Computer system 2001 also includes a main memory 2007 which is preferably random access memory (RAM). Computer system 2001 may also include a secondary memory 2008. Secondary memory 2008 may include, for example, a hard disk drive 2010 and/or a removable storage drive 2012, representing a floppy disk drive, a magnetic tape drive, an optical disk drive, etc. Removable storage drive 2012 reads from and/or writes to a removable storage unit 2014 in a well known manner. Removable storage unit 2014 represents a floppy disk, magnetic tape, optical disk, etc., which is read by and written to by removable storage drive 2012. As will be appreciated, the removable storage unit 2014 includes a computer usable storage medium having stored therein computer software and/or data.

In alternative embodiments, secondary memory 2008 may include other similar means for allowing computer programs or other instructions to be loaded into computer system 2001. Such means can include, for example, a removable storage unit 2022 and an interface 2020. Examples can include a program cartridge and cartridge interface (such as that found in video game devices), a removable memory chip (such as an EPROM, PROM, or flash memory) and associated socket, and other removable storage units 2022 and interfaces 2020 which allow software and data to be transferred from the removable storage unit 2022 to computer system 2001.

Computer system 2001 may also include a communications interface 2024. Communications interface 2024 allows software and data to be transferred between computer system 2001 and external devices via communications path 2027. Examples of communications interface 2027 include a modem, a network interface (such as Ethernet card), Bluetooth and/or other short-range wireless network modules, etc. Software and data transferred via communications interface 2027 are in the form of signals 2028 which can be electronic, electromagnetic, optical or other signals capable of being received by communications interface 2024, via communications path 2027. Note that communications interface 2024 provides a means by which computer system 2001 can interface to a network such as the Internet.

The various embodiments can be implemented using software running (that is, executing) in an environment similar to that described above with respect to FIG. 20. In this document, the term “computer program product” is used to generally refer to removable storage units 2014 and 2022, a hard disk installed in hard disk drive 2010, or a signal carrying software over a communication path 2027 (wireless link or cable) to communication interface 2024. A computer useable medium can include magnetic media, optical media, or other recordable media, or media that transmits a carrier wave or other signal. These computer program products are means for providing software to computer system 2001.

Computer programs (also called computer control logic) are stored in main memory 2007 and/or secondary memory 2008. Computer programs can also be received via communications interface 2024. Such computer programs, when executed, enable the computer system 2001 to perform the various features as discussed herein. In particular, the computer programs, when executed, enable the processor 2004 to perform the various features described herein. Accordingly, such computer programs represent controllers of the computer system 2001.

The various embodiments can be implemented as control logic in software, firmware, hardware or any combination thereof. In an embodiment implemented using software, the software may be stored in a computer program product and loaded into computer system 2001 using removable storage drive 2012, hard drive 2010, or interface 2020. Alternatively, the computer program product may be downloaded to computer system 2001 over communications path 2027. The control logic (software), when executed by the one or more processors 2004, causes the processor(s) 2004 to perform the functions of the various embodiments as described herein.

In another embodiment, the various features and functions may be implemented primarily in firmware and/or hardware using, for example, hardware components such as application specific integrated circuits (ASICs). Implementation of a hardware state machine so as to perform the functions described herein will be apparent to persons skilled in the relevant art(s).

### VI. Conclusion

While various embodiments of the present inventions have been described above, it should be understood that they have been presented by way of example only, and not limitation. Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of processing information in a communications device, comprising:
receiving from a first remote device protected content along with pricing attribute information for the protected content;
requesting access to the protected content from a second remote device, the requesting including transmitting of the pricing attribute information to the second remote device which is authorized to act on behalf of a provider of the content; and
obtaining access to the protected content from the second remote device according to a pricing or valuation of the protected content based on the pricing attribute information received by the second remote device.

2. The method according to claim 1, wherein the pricing attribute information comprises a quality of the content as recorded.

3. The method according to claim 2, wherein the quality of the content comprises a qualification or quantification of error in the content as recorded.

4. The method according to claim 1, wherein the pricing attribute information comprises whether the content includes or excludes advertisements as recorded.

5. The method according to claim 1, wherein the pricing attributes information comprises a location of where the content was recorded for distribution.

6. The method according to claim 1, wherein the pricing attribute information comprises whether the content has been modified or not.

7. The method according to claim 1, wherein the received pricing attribute information, from the first remote device, is protected.

8. The method according to claim 7, wherein the protected pricing attribute information is encrypted with a pricing attribute key.

9. The method according to claim 7, wherein the protected pricing attribute information has provided therewith a message authentication code (MAC) generated using a pricing attribute key.

10. The method according to claim 7, wherein the protected pricing attribute information has provided therewith a digital signature or certificate associated with the first remote device.

11. The method according to claim 10, wherein the digital signature or certificate is encoded or encrypted with a public key of the first remote device.

12. The method according to claim 1, wherein the obtaining access operation comprises receiving a key from the second remote device to facilitate decryption of the encrypted content.

13. The method according to claim 1, wherein the protected content is encrypted.

14. The method according to claim 13, wherein the obtaining access operation comprises receiving a key to decrypt the encrypted content.

15. A method implemented by a communications device, comprising:
obtaining authorization to make a recording of content from a content provider through a service;
receiving protected content from the content provider;
making an authorized recording of the protected content in a file, the file further including information corresponding to pricing attributes for subsequent valuation of the recorded content when redistributed; and
transmitting a copy of the file with the protected content and the information corresponding to the pricing attributes to another party.

16. The method according to claim 15, wherein the file includes a header having a recording information block (RIB) which is encoded with the information corresponding to the pricing attributes.

17. The method according to claim 16, wherein the RIB is authenticated with a RIB authentication key (RIBAK).

18. The method according to claim 16, wherein the RIB is encrypted with a randomly generated symmetric key.

19. The method according to claim 15, further comprising:
obtaining a pricing attribute key; and
protecting the information corresponding to pricing attributes using the received pricing attribute key.

20. The method according to claim 19, wherein the pricing attribute key is received during registration with the service through a remote party.

21. The method according to claim 19, wherein the pricing attribute key is generated based on another key received with the service through a remote party.

22. The method according to claim 19, wherein the protecting operation encrypts the pricing attribute information using the obtained pricing attribute key.

23. The method according to claim 19, wherein the protecting operation adds a message authentication code (MAC) generated with the pricing attribute key to the pricing attribute information.

24. The method according to claim 19, wherein the protecting operation adds a digital certificate or signature associated with the authorized communications device to the pricing attribute information.

25. The method according to claim 15, further comprising:
modifying the received content; and
having the information corresponding to the pricing attributes reflect a nature of the modification.

26. The method according to claim 25, further comprising:
obtaining authorization from a rights issuer to access the modified content.

27. The method according to claim 15, wherein the protected content is encrypted.

28. A method comprising:
receiving from a communications device a request for access to protected content obtained by the communications device and having associated therewith pricing attribute information, the request including the pricing attribute information for the protected content;
verifying that the received pricing attribute information has not been altered or is valid;
determining a price for access of the protected content by the communications device according to the verified pricing attribute information; and
transmitting a key to the communications device to allow access to the protected content upon payment of the price.

29. The method according to claim 28, wherein the protected content was superdistributed to the communications device in a file having a header that includes the pricing attribute information.

30. The method according to claim 29, wherein the pricing attribute information is maintained in a recording information block (RIB) of the header.

31. The method according to claim 30, wherein the received pricing attribute information is encoded with or encrypted using a randomly generated symmetric key.

32. The method according to claim 30, wherein the verifying comprising authenticating the received pricing attributes information using a RIB authentication key (RIBAK).

33. The method according to claim 28, wherein the received pricing attribute information is encoded with a digital certificate, the verifying operation determining whether the digital certificate belongs to an authorized recipient of the protected content.

34. The method according to claim 28, wherein the received pricing attribute information is encrypted with a pricing attribute key, the verifying operation decrypting the pricing attribute information using the pricing attribute key.

35. The method according to claim 28, wherein the received pricing attribute information has appended thereto a message authentication code (MAC) generated using a pricing attribute key, the verifying operation authenticating the pricing attribute information based on the received MAC and pricing attribute key.

36. An apparatus, comprising:
communications interface(s) for receiving and transmitting information; and
one or more processors executing computer executable code to facilitate control of the following operations:
receiving from a first remote device protected content along with pricing attribute information for the protected content;
requesting access to the protected content from a second remote device, the requesting including transmitting of the pricing attribute information to the second remote device which is authorized to act on behalf of a provider of the content; and
obtaining access to the protected content from the second remote device according to a pricing or valuation of the protected content based on the pricing attribute information received by the second remote device.

37. An apparatus, comprising:
communications interface(s) for receiving and transmitting information; and
one or more processors executing computer executable code to facilitate control of the following operations:
obtaining authorization to make a recording of content from a content provider through a service;
receiving protected content from the content provider;
making an authorized recording of the protected content in a file, the file further including information corresponding to pricing attributes for subsequent valuation of the recorded content when redistributed; and
transmitting a copy of the file with the protected content and the information corresponding to the pricing attributes to another party.

38. An apparatus, comprising:
communications interface(s) for receiving and transmitting information; and
one or more processors executing computer executable code to facilitate control of the following operations:
receiving from a communications device a request for access to protected content obtained by the communications device and having associated therewith pricing attribute information, the request including the pricing attribute information for the protected content;
verifying that the received pricing attribute information has not been altered or is valid;
determining a price for access of the protected content by the communications device according to the verified pricing attribute information; and
transmitting a key to the communications device to allow access to the protected content upon payment of the price.

39. A tangible computer medium having computer executable code which when executed by a computer performs the following method comprising:
receiving from a first remote device protected content along with pricing attribute information for the protected content;
requesting access to the protected content from a second remote device, the requesting including transmitting of the pricing attribute information to the second remote device which is authorized to act on behalf of a provider of the content; and
obtaining access to the protected content from the second remote device according to a pricing or valuation of the protected content based on the pricing attribute information received by the second remote device.

40. A tangible computer medium having computer executable code which when executed by a computer performs the following method comprising:
obtaining authorization to make a recording of content from a content provider through a service;
receiving protected content from the content provider;
making an authorized recording of the protected content in a file, the file further including information corresponding to pricing attributes for subsequent valuation of the recorded content when redistributed; and
transmitting a copy of the file with the protected content and the information corresponding to the pricing attributes to another party.

41. A tangible computer medium having computer executable code which when executed by a computer performs the following method comprising:
receiving from a communications device a request for access to protected content obtained by the communications device and having associated therewith pricing attribute information, the request including the pricing attribute information for the protected content;
verifying that the received pricing attribute information has not been altered or is valid;
determining a price for access of the protected content by the communications device according to the verified pricing attribute information; and
transmitting a key to the communications device to allow access to the protected content upon payment of the price.
